(19) United States
(12) Patent Application Publication
(10) Pub. No.: US 2006/0051528 A1
(43) Pub. Date: Mar. 9, 2006

(54) Recording sheets and image forming method using the recording sheets

(75) Inventors: Takashi Ogino, Kanagawa (JP); Kiyoshi Hosoi, Kanagawa (JP); Chizuru Koga, Kanagawa (JP); Tsukasa Matsuda, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/060,743

(22) Filed: Feb. 18, 2005

(30) Foreign Application Priority Data
Sep. 9, 2004 (JP) 2004-262628
Sep. 9, 2004 (JP) 2004-262303

(51) Int. Cl. B41M 5/00

(52) U.S. Cl. 428/32.21

(57) ABSTRACT

A recording sheet obtained by coating a base paper including pulp with a surface sizing agent including a starch as a main component, wherein the recording sheet exhibits a reflection density in a specific range when provided with a povidone-iodine liquid. Also disclosed is a recording sheet prepared by coating the surface of a base paper including a pulp fiber and a filler as main components with a processing liquid including a starch, wherein when 0.06 m² of the recording sheet is subjected to hot water extraction, a solid amount of an extract is 0.01 to 0.4 g and a carboxyl group content in the solid is 0 to 5 meq/100 g.

### CROSS-REFERENCE TO RELATED APPLICATION

This application claims priority under 35 USC 119 from Japanese patent Application Nos. 2004-262628 and 2004-262303, the disclosures of which are incorporated by reference herein.

### BACKGROUND OF THE INVENTION

1. Field of the Invention

The present invention is concerned with recording sheets, electrophotographic image forming method using the recording sheets, and ink-jet image forming method using the recording sheets.

2. Description of the Related Art

Copy machines and laser printers utilizing the electrophotograhic method are essential tools in offices. Plain paper is used in such machines. The plain paper is a recording paper which does not have a coating including a pigment.

Ink-jet recording method has become popular in offices since the method enables easy colorization, uses less energy, creates less recording noise, and reduces the production cost of the printers. Therefore, the so-called plain paper used in offices has to have such characteristics that the plain paper can be used in the electrophotographic recording method and in the ink-jet recording method without troubles.

However, in the electrophotographic recording method, paper curls when a toner image which has been transferred onto the paper is thermally fixed. This is because only one side of the paper is heated at the thermal fixation and the moisture of the paper is removed only from the heated surface. Therefore, there have been problems such as paper jamming at paper ejection section and accumulation defects on the catch tray.

A lot of proposals have been made in order to solve the problem of the post-printing curl. An example thereof (disclosed in Japanese Patent Application Laid-Open (JP-A) No. 5-341554) focuses attention to the strain inherent to sheets and the proposed method comprises subjecting a transfer sheet to tension drying when the sheet is made and dried. Another example thereof comprises controlling the moisture when paper is packaged so as to reduce the moisture content of the paper, thus reducing the elongation of the paper upon absorption of water. For example, methods are proposed in JP-A Nos. 5-241366 and 7-219262 which defines the moisture content of the coated paper immediately after the calendering treatment.

Another method is proposed in JP-A No. 6-138688 which reduces the difference in fiber orientation between the two surfaces of paper and which defines the moisture content at the time of opening the package. It is considered that the difference in elongation characteristic between the two surfaces is reduced by reducing the difference in fiber orientation between the two surfaces. However, the most popular way to fix the toner in the thermal fixing section of the electrophotographic method is sandwiching the sheet between a heating member and a pressing member. Since the heating member and the pressing member have different temperatures, difference in elongation develops between the two surfaces. Therefore, it is difficult to suppress the curl after thermal fixing by the method. Even when the moisture content of paper at the time of opening the package is made low, the paper absorbs moisture after the package is opened. Accordingly, the low moisture content in the package makes little contribution to suppression of the curl after thermal fixing.

Another method is disclosed in JP-A No. 8-123066 which defines the moisture content of paper coated with a porous pigment layer at the time of opening the package. However, the pore is provided to the pigment layer in order to improve the image quality and the existence of the pore does not have influence on the curl after thermal fixing. Further, as described above, even when the moisture content of paper at the time of opening the package is made low, the paper absorbs moisture after the package is opened. Accordingly, the low moisture content in the package makes little contribution to suppression of the curl after thermal fixing.

Another method is disclosed in JP-A No. 11-282193 which defines the elongation degree of paper in water and the moisture content of the paper at the time of opening the package. However, the curl after thermal fixing is a dimensional change of a sheet in the dry state. Accordingly, it is impossible to suppress the curl after thermal fixing by controlling the elongation degree in water since the elongation degree in water is a dimensional change of a sheet in the extremely wet state. As recited above, even when the moisture content of paper at the time of opening the package is made low, the paper absorbs moisture after the package is opened. Accordingly, the low moisture content in the package makes little contribution to suppression of the curl after thermal fixing.

In JP-A No. 6-202371, a method is disclosed which defines the moisture content in a condition of 28° C. 85% RH, in addition to the moisture content in the package. This method defines the difference between the equilibrium moisture content in a high-humidity environment and the moisture content at the time of opening the package. This method, too, focuses on how easily a sheet absorbs moisture. Therefore, this method is not sufficiently effective in suppression of the curl after thermal fixing caused by dehydration. Still other method are disclosed in JP-A Nos. 6-295087 and 11-338181. However, these methods are not sufficiently effective in suppression of the curl after thermal fixing either.

JP-A No. 3-287894 discloses a method which defines the moisture content of paper including recycle paper in a condition of 20° C. 65% RH. However, this method focuses on how easily a sheet absorbs moisture. Therefore, this method is not sufficiently effective in suppression of the curl after thermal fixing caused by dehydration.

Copy machines and printers have developed, so that they are downsized and have multi-functions such as automatic double-side copy and automatic binding. With the development of the copy machines and printers, the mechanisms and the paper paths of the instruments has become complicated, the diameters of the thermal fixing rolls have become smaller, and the thermal fixing rolls has become complicated. Therefore, even if the difference in dimensional change between the two sides of a sheet is reduced by the above techniques, the sheets develop heavy curl when the sheets are used in a high-humidity condition. This curl is remarkable particularly when the sheets are used for printing with small printers which heat only one side of the sheets. Owing to the developed curl, the ends of the sheets are likely to contact with members in the instruments and easily causes paper jamming. Therefore, the curl after thermal fixing cannot be suppressed satisfactory by the conventional methods as described above.

The ink-jet recording method also has problems when the method is used for printing on plain paper. For example, the colorant is unlikely to remain on the sheets whereby the color developability is insufficient. Further, the recorded image is not sufficiently resistant to water since water-soluble colorants are used. These problems have not been solved by the conventional techniques described above.

In order to solve the problems, a method is proposed in Japanese Patent No. 296368. In the method, inks including water-soluble dyes are used in recording on sheets including ionic substances having the opposite ionic polarity to the water-soluble dyes in the inks. However, if sheets having insufficient water-repelling property are used for printing by this method with quick-drying inks such as inks used for high-speed printers, the color developability deteriorates. This is because the inks penetrate into the sheets very rapidly and the colorants in the inks reach the interior of the sheets, thus reducing the relative amount of the colorant remaining on the surface of the sheets.

In the above method, since the sheets include large amounts of highly ionic substances, the sheets are excessively affected by changes of the surroundings, so that the electric resistance of the sheets lowers. Accordingly, the sheets may cause adverse effects on the toner transferability in electrophotographic printers or electrophotographic copy machines. Consequently, there have been no conventional sheets which can solve the problems of both electrophotographic recording and ink-jet recording (See JP-A Nos. 10-166713 and 7-257017). Further, the curl of the sheets after thermal fixing cannot be suppressed by the conventional techniques.

In the conventional ink-jet printers, generally, the black ink includes a pigment and penetrates slowly into the recording sheet and the color inks include dyes and penetrate quickly into the recording sheet, so that the quality of black letters can be improved and intercolor bleed can be suppressed. However, if color inks capable of penetrating quickly into the recording sheet are used for printing an image with a high recording density, heavy curl of the sheet develops immediately after the printing whereby paper jamming in the printer or scratch in image areas occurs.

Further, since it takes time for the curl of the recording sheet immediately after printing to relax or it takes time for ink to dry, printing efficiency is very low in the case of double-side printing. When an image with high recording density is printed, the curl developing after air drying is heavy. Therefore, the high quality and suppression of the curl cannot be satisfied simultaneously to a sufficient degree.

As described above, the curl of the recording sheet is a big issue both in the electrophotographic system and the ink-jet system.

In addition to the methods described above, various other methods have been proposed in order to suppress the curl of the recording sheet in the electrophotographic system. Examples thereof include: a method controlling the residual curvature of the transfer sheet disclosed in JP-A No. 3-243953; a method controlling the difference in ash content disclosed in JP-A Nos. 7-202897 and 7-295280, the method focusing on the difference in characteristics between the two sides of a transfer sheet; a method controlling the difference in elongation ratio disclosed in JP-A No. 3-236062, a method controlling the difference in paper density disclosed in JP-A No. 58-176641; and a method controlling the difference in freeness disclosed in JP-A No. 6-110243.

However, even if the difference in dimensional change between the two sides of a sheet is reduced by the above techniques, the sheets develop heavy curl when the sheets are used in a high-humidity condition. This curl is remarkable particularly when the sheets are used for printing with small printers which heat only one side of the sheets. Owing to the developed curl, the ends of the sheets are likely to contact with members in the instruments and easily causes paper jamming.

In order to suppress the curl developing in the ink-jet system, methods are proposed in JP-A Nos. 10-046498 and 2002-201597 which use formaldehyde resins or the like to suppress the elongation upon absorption of water so as to suppress the curl. However, if the curl-suppressing material is mixed with the sheet material before papermaking, cellulose fibers in the sheet flocculate owing to the high reactivity of the curl-suppressing material, whereby the quality of the surface deteriorates greatly.

Even if the curl-suppressing material is provided by size-pressing, the curl-suppressing material initiates a reaction before being coated and the surface sizing liquid becomes viscous and flocculates. Therefore, the amount of the curl-suppressing material reaching cellulose fibers in the sheet is reduced, thus sufficient curl-suppressing effect cannot be obtained.

In the image recording by the ink-jet recording method, various starches such as enzymatically modified starches and cationized starches are used as surface-sizing agents with the aim of preventing bleeding.

As enzymatically modified starches, various starches treated with amylase have been reported (for example in JP-A Nos. 1-156595, 1-162894, 2-3000, 2000-307813, and 10-219596, and Japanese Patent Nos. 3237104 and 2936996). Use of an enzymatically modified starch in recording sheets is effective in preventing bleed, but not sufficiently effective in suppressing the curl.

JP-A No. 2004-143612 proposes a recording sheet using a cationized starch as a surface sizing agent for suppressing the curl. However, when the cationized starch penetrates into the interior of the sheet, the cationized starch enhances formation of hydrogen bonds between cellulose fibers. Therefore, the curl after thermal fixing gets heavier by the use of the cationized starch when the sheet is used for electrophotographic image recording in a condition of high humidity. The curl develops also when the sheet is used in an ink-jet recording system which uses a large amount of water, and the periphery of the sheet contacts with members in the machine to easily cause paper jamming or the like. As described above, the curl is not sufficiently prevented by the use of a starch as a surface sizing agent in the recording sheet according to the conventional techniques.

### SUMMARY OF THE INVENTION

The invention has been made in consideration of the above problems of the conventional techniques.

An aspect of the invention is to provide a recording sheet. The recording sheet is obtained by coating a base paper including pulp with a surface sizing agent including a starch as a main component. When the recording sheet is left in a condition of 23° C. 50% RH for 5 hours and then the surface of the recording medium is provided with a povidone-iodine liquid having a povidone-iodine concentration of 70 mg/ml and an effective iodine content of 7 mg/ml in an amount of 10 ml/m² and then the recording sheet is left in a condition of 23° C. 50% RH for 5 hours, the reflection density of the surface provided with the povidone-iodine liquid is 0.60 or lower.

Another aspect of the invention is to provide an image recording method. The image recording method comprises: uniformly charging the surface of an electrostatic latent image holding member; exposing the surface of the electrostatic latent image holding member to form an electrostatic latent image; developing the electrostatic latent image with an electrostatic developer to form a toner image; transferring the toner image to the surface of a recording sheet; and fixing the toner image to the surface of the recording sheet. In this method, the recording sheet was produced by coating a base paper including pulp with a surface sizing agent including a starch as a main component. The recording sheet is such a sheet that when the recording sheet is left in a condition of 23° C. 50% RH for 5 hours and then the surface of the recording medium is provided with a povidone-iodine liquid having a povidone-iodine concentration of 70 mg/ml and an effective iodine content of 7 mg/ml in an amount of 10 ml/m² and then the recording sheet is left in a condition of 23° C. 50% RH for 5 hours, the reflection density of the surface provided with the povidone-iodine liquid is 0.60 or lower.

Another aspect of the invention is to provide an ink-jet recording method. The recording method comprises providing ink droplets to a recording sheet to record an image on the surface of the recording sheet. In this method, the recording sheet was produced by coating a base paper including pulp with a surface sizing agent including a starch as a main component. The recording sheet is such a sheet that when the recording sheet is left in a condition of 23° C. 50% RH for 5 hours and then the surface of the recording medium is provided with a povidone-iodine liquid having a povidone-iodine concentration of 70 mg/ml and an effective iodine content of 7 mg/ml in an amount of 10 ml/m² and then the recording sheet is left in a condition of 23° C. 50% RH for 5 hours, the reflection density of the surface provided with the povidone-iodine liquid is 0.60 or lower.

As a result of intensive study on the mechanism of the curling after thermal fixing conducted by the inventors of the present invention, it has been found that: the curl after thermal fixing is suppressed in the electrophotographic recording method and the color rendition is improved in the ink-jet recording method if the recording sheet whose surface is coated with a processing liquid including a starch is such a recording sheet that the solid obtained by hot water extraction of the recording sheet has a carboxyl group content of 0 to 5 meq/100 g.

Recording sheets used for electrophotographic recording methods include conductive agents. The inventors have also found that high color rendition can be achieved in ink-jet recording while maintaining the transferability in electrophotographic recording by treating the surface of the recording sheets with multivalent metal salts as conductive agents to a predetermined degree. Specifically:

Another aspect of the invention is to provide a recording sheet prepared by coating the surface of a base paper including a pulp fiber and a filler as main components with a processing liquid including a starch. The recording sheet is such a recording sheet that when 0.06 m² of the recording sheet is subjected to hot water extraction, the solid amount of the extract is 0.01 to 0.4 g and the carboxyl group content in the solid is 0 to 5 meq/100 g.

In an embodiment, the processing liquid includes a di- or higher-valent metal salt, and in a condition of 23° C. 50% RH, the recording sheet has a ratio of surface electric resistivity to volume electric resistivity in the range of 0.1 to 1, a surface electric resistivity of 1.0×10⁹ to 1.0×10¹¹ Ω/sq, and a volume electric resistivity of 5.0×10⁹ to 5.0×10¹¹ Ω·cm.

The starch in the processing liquid may have carboxyl groups in an amount of 0 to 5 meq/100 g.

Another aspect of the invention is to provide a image recording method. The image recording method comprises: uniformly charging the surface of an electrostatic latent image holding member; exposing the surface of the electrostatic latent image holding member to form an electrostatic latent image; developing the electrostatic latent image with an electrostatic developer to form a toner image; transferring the toner image to the surface of a recording sheet; and fixing the toner image to the surface of the recording sheet. In this method, the recording sheet is selected from the above-described recording sheets.

Another aspect of the invention is to provide an image recording method. The image recording method comprises providing the surface of a recording sheet with an ink droplet including a colorant and at least one of water and a water-soluble organic solvent. In this method, the recording sheet is selected from the above-described recording sheets.

Another aspect of the invention is to provide a recording sheet obtained by coating a base paper including pulp with a surface sizing agent including a starch as a main component, wherein when the recording sheet is left in a condition of 23° C. 50% RH for 5 hours and then the surface of the recording medium is provided with a povidone-iodine liquid having a povidone-iodine concentration of 70 mg/ml and an effective iodine content of 7 mg/ml in an amount of 10 ml/m² and then the recording sheet is left in a condition of 23° C. 50% RH for 5 hours, the reflection density of the surface provided with the povidone-iodine liquid is 0.60 or lower; and when 0.06 m² of the recording sheet is subjected to hot water extraction, a solid amount of an extract is 0.01 to 0.4 g and a carboxyl group content in the solid is 0 to 5 meq/100 g. The base paper of the recording sheet may further include a filler. The surface sizing agent may include a di- or higher-valent metal, and in a condition of 23° C. 50% RH, the recording sheet may have a ratio of surface electric resistivity to volume electric resistivity in the range of 0.1 to 1, a surface electric resistivity of 1.0×10⁹ to 1.0×10¹¹ Ω/sq, and a volume electric resistivity of 5.0×10⁹ to 5.0×10¹¹ Ω·cm.

The starch used in the above aspects may be a starch prepared by a method comprising: mixing a starch and water to form an aqueous starch solution; heating the aqueous starch solution, so as to gelatinize the aqueous starch solution; then aging the aqueous starch solution at a temperature which is lower than a heating temperature of the gelatinization; then enzymatically modifying the starch by adding an enzyme to the aqueous starch solution; and then heating the aqueous starch solution so as to inactivate the enzyme and to stop the reaction.

### BRIEF DESCRIPTION OF THE DRAWINGS

FIG. 1 is a schematic diagram for explaining the method for measuring the curl height represented by h.

### DESCRIPTION OF THE INVENTION

In the following, the invention will be explained using the headings of “First embodiment” and “Second embodiment”.

First Embodiment

Recording sheet

In a first embodiment, the invention provides a recording sheet obtained by coating a base paper including pulp with a surface sizing agent including a starch as a main component, wherein when the recording sheet is left in a condition of 23° C. 50% RH for 5 hours and then the surface of the recording medium is provided with a povidone-iodine liquid having a povidone-iodine concentration of 70 mg/ml and an effective iodine content of 7 mg/ml in an amount of 10 ml/m² and then the recording sheet is left in a condition of 23° C. and 50% RH for 5 hours, the reflection density of the surface provided with the povidone-iodine liquid is 0.60 or lower.

When image recording is conducted by electrophotographic or ink-jet copy machines or printers using the recording sheet of the first embodiment, the curl can be suppressed.

The reflection density is an index expressing the coloring degree of the region on the surface of a recording sheet, the region being colored by the color reaction between iodine and starch. The coloring degree is affected by the form of the starch. It is known that if the glucose chain of the starch is shorter, iodine is less likely to be incorporated into the helix structure of the glucose chain, thereby reducing the reflection density. It is also known that the hydrophobicity is heightened by the crystallization of the starch owing to aging and that the heightened hydrophobicity lowers the ability to adsorb iodine, thereby reducing the reflection density.

In other words, higher hydrophobicity of the starch results in decrease in the reflection density. Therefore, as the reflection density becomes lower, the variation in moisture content of the portion of the recording sheet near the surface caused by the heat of the thermal fixing in electrophotographic image recording becomes lower, whereby the curl can be more easily suppressed. In ink-jet image recording, if the reflection density is lower, less water is absorbed immediately after the printing, whereby the amount of moisture which once penetrates into the recording sheet then evaporates in the drying process after the printing is reduced, thus enabling easier suppression of the curl immediately after printing and the curl after air drying of the recording sheet.

Therefore, in order to suppress the curl, the reflection density may be 0.6 or lower, preferably 0.57 or lower, more preferably 0.55 or lower, still more preferably 0.53 or lower in the case of the recording sheet of the first embodiment. Lower reflection density is more preferred in the invention.

However, at least a certain amount of a starch has to be provided to the recording sheet in order to prevent bleed at ink-jet printing. The starch may be mixed with the ingredients of the sheet prior to the paper-making, and/or applied to the recording sheet after the paper-making. Accordingly, the reflection density is preferably 0.30 or higher, and more preferably 0.35 or higher.

The reflection density is determined by: leaving the recording sheet in a condition of 23° C. 50% RH for 5 hours so as to control the moisture content; and then providing the surface of the recording medium with a povidone-iodine liquid having a povidone-iodine concentration of 70 mg/ml and an effective iodine content of 7 mg/ml in an amount of 10 ml/m²; and then leaving the recording sheet in a condition of 23° C. 50% RH for 5 hours; and then measuring the reflection density of the surface by a reflection density measuring instrument.

Although povidone-iodine liquid is cited herein as an iodine source for the iodo-starch reaction, commercially available povidone-iodine gargles may be used instead, as long as the same effective amount of iodine is provided to the unit area on the surface of the recording sheet. The povidone-iodine liquid may be provided to the surface of the recording sheet by a coating method or a spraying method, as long as the liquid is provided uniformly onto the surface in an amount of 10 ml/m² (in terms of the undiluted solution).

In the measurement of the reflection density (visual density), X-RITE 938 manufactured by X-rite is used as the measuring instrument, D50 light source is used as the light source, the measurement field is 2° field, and the aperture size is 8 mm. In the measurement, the reflection density values of ten points in a patch having a size of 50 mm×50 mm are measured and the average value of the ten values is considered as the reflection density of the sheet, wherein the patch is arbitrarily selected from the region colored by the iodo-starch reaction.

The scope of the term “a starch” used herein includes starch and starch derivatives such as enzymatically-modified starches which have been subjected to treatments with enzymes. The starch used in the surface sizing agent and the treatment applied to the starch is not particularly limited as long as the resultant recording sheet exhibits a recording density of 0.6 or lower in the above-described measurement. In an embodiment, two or more kinds of starches are used in combination.

The starch used in the recording sheet of the first embodiment is preferably an oxidized starch which has been conventionally used as a surface sizing agent, or a starch having higher hydrophobicity than usual starches such as an enzymatically-modified starch. The starch may be an enzymatically-modified starch prepared by the following process.

The preferred enzymatically-modified starch (occassionally referred to as “enzymatically-modified starch F” hereinafter) is prepared by: heating an aqueous starch solution, so as to gelatinize the aqueous starch solution; then aging the aqueous starch solution at a temperature which is lower than the heating temperature of the above heating; then enzymatically modifying the starch by adding an enzyme to the aqueous starch solution; and then heating the aqueous starch solution so as to inactivate the enzyme and to stop the reaction.

On the other hand, in the preparation of a conventional enzymatically modified starch, the aqueous starch solution is heated simultaneously with the addition of the enzyme, then cooled. In the conventional process, the aging process in the above method of the invention is omitted and, in effect, the heating for gelatinizing the starch solution and the heating for inactivating the enzyme is conducted simultaneously.

When the enzymatically-modified starch F is used as the surface sizing agent, it is easy to obtain a recording sheet which exhibits a reflection density of 0.6 or lower in the above measurement. Therefore, the enzymatically-modified starch F is highly effective in suppressing and preventing curl. This is supposedly because the enzymatically-modified starch F has higher hydrophobicity than conventional starches. The reason for the high hydrophobicity of the enzymatically-modified starch F is supposed to be as follows: During the aging subsequent to the heating for gelatinizing the starch solution, the starch which dissolved and swelled in the heating for gelatinizing the starch solution recrystallizes and absorption of water by the recrystallized starch is suppressed to enhance the hydrophobicity of the obtained enzymatically-modified starch F. The preparation of the enzymatically-modified starch F is preferably conducted in the following conditions.

Gelatinization

The starch used in the preparation is not particularly limited and may be a conventional starch such as corn starch, tapioca starch, Irish potato starch, wheat starch, or rice starch.

The concentration of starch in the aqueous starch solution is preferably 8 to 20% by weight, more preferably 10 to 15% by weight. The temperature at the heating (for gelatinizing the starch solution) is preferably 90 to 120° C., more preferably 95 to 100° C. The processing time is preferably 20 to 60 minutes, more preferably 30 to 45 minutes.

Aging

The starch solution after the gelatinization is naturally cooled or forcibly cooled with ice water or the like, then subjected to aging at a low temperature. The temperature at the aging is preferably 20 to 50° C., more preferably 25 to 40° C. The processing time is preferably 60 to 180 minutes, more preferably 60 to 120 minutes.

Modification

The starch solution after the aging is enzymatically modified by addition of an enzyme. The enzyme may be, for example, α-amylase, β-amylase, or glucoamylase. The amount of the enzyme to be used (the enzyme concentration) is preferably 0.01 to 1.00 weight % of the amount of starch, more preferably 0.02 to 0.5 weight % of the amount of starch. The reaction time (the length of time between the addition of an enzyme and the initiation of the subsequent process for inactivation of the enzyme) is preferably 1 to 10 minutes, more preferably 1 to 3 minutes.

Inactivation

After the modification, the starch solution is heated to a high temperature so as to inactivate the enzyme and to stop the enzymatic modification reaction. The temperature at the heating is preferably 90 to 120° C., more preferably 95 to 100° C. The processing time is preferably 5 to 20 minutes, and more preferably 6 to 10 minutes.

A specific example of the preparation of the enzymatically-modified starch F is described below.

A container containing 180 g of 8 weight % corn starch liquid is put in a hot-water bath (95° C. or higher) and the corn starch liquid is allowed to boil for 30 minutes (gelatinization). Then, the corn starch liquid is cooled to 40° C. over about 30 minutes by putting the container in an ice water bath or the like. The corn starch liquid is put in small bottles and the bottles are left in a hot-water bath of 40° C. for 30 minutes (aging). Then, a predetermined amount of an enzyme (α-amylase with a product name “KLEISTASE PA”) is added to each bottle and the corn starch liquid in the bottle is vigorously stirred for about 2 minutes (modification). After the stirring, the bottles are put in a boiling hot-water bath (95° C. or higher) and left for 6 minutes so as to inactivate the enzyme (inactivation). Then, the starch liquid is cooled to room temperature and used as a surface sizing agent.

For reference purpose, the preparation process of conventional enzymatically-modified starch is described below. In the preparation, a container containing a liquid including 20 to 30 weight % corn starch and a predetermined amount of an enzyme (α-amylase with a product name “KLEISTASE PA”) is put in a hot-water bath (95° C. or higher) and the starch liquid is allowed to boil for 30 minutes. Then, the starch liquid is cooled to room temperature and used as a surface sizing agent.

The hydrophobicity of the enzymatically-modified starch F can be controlled by suitably adjusting the conditions in each process, for example by adjusting the enzyme concentration during the modification of the starch.

In order to suppress the curl, the conditions may be selected such that the recording sheet obtained by coating a base paper with a surface sizing liquid including the enzymatically-modified starch F exhibits a reflection density of 0.6 or lower when processed and measured by the procedure described above. The conditions are preferably selected in consideration of not only the reflection density but also the production process of the recording sheet. For example, if the starch has been excessively modified with enzymes, the viscosity of the surface sizing liquid is too low and problems such as dripping of the liquid are likely to occur.

Conventional techniques have tried to improve the penetration of a surface sizing agent into a sheet, and to suppress curl which may cause paper jamming in double-sided copy or printing, by reducing the difference between the two sides of a sheet or by using a conventional enzymatically-modified starch or the like.

However, when an image is formed on a conventional recording sheet in a high humidity condition by a copy machine or printer which has such a mechanism that one side of the sheet is more strongly heated than the other side, paper jamming is likely to occur during double-sided copy or double-sided print. This is because the dimensional change of the side of the sheet to which heat is applied is likely to be larger than the dimensional change of the other side, thus developing severe curl.

On the other hand, when the starch with higher hydrophobicity such as the enzymatically-modified starch F is used as the surface sizing agent, the dimensional change of the side to which heat is applied is not remarkably larger than the dimensional change of the other side. Therefore, paper jamming during double-sided copy or printing can be suppressed.

In the preparation of the recording sheet of the first embodiment, the surface sizing agent is provided to the surface of the recording sheet by coating a base paper with a surface sizing liquid including the surface sizing agent. The concentration of the surface sizing agent in the surface sizing liquid is preferably 5 to 15% by mass, more preferably 8 to 12% by mass.

The surface sizing agent is particulaly preferably the enzymatically-modified starch F. Other surface sizing agents such as polyvinyl alcohol and conventional starches (such as conventional enzymatically-modified starches and oxidized starches) may be used in addition, as long as the reflection density is maintained 0.6 or lower.

The amount of the surface sizing agent adhered to the sheet is preferably 0.1 to 5.0 g/m² per one side, more preferably 1.0 to 3.0 g/m² per one side.

If the amount of the surface sizing agent adhered per one surface exceeds 5.0 g/m², the amount of the surface sizing agent on the surface of the recording sheet is large, whereby the contact points between the cellulose fibers in the recording sheet is increased. The increased contact points sometimes intensify curl and cockle. If the amount of the surface sizing agent adhered per one surface is below 0.1 g/m², the amount of the surface sizing agent on the surface of the recording sheet is small, whereby the surface sizing agent fails to fix the pigment or the like applied simultaneously with the surface sizing agent to the surface of the base paper. Therefore, when the resultant recording sheet is transferred in an electrophotographic or ink-jet image forming instrument, a lot of paper dust is likely to develop during the transfer which may cause machine troubles.

The recording sheet of the first embodiment has a formation index of preferably 10 to 50, more preferably 15 to 40. If the formation index is lower than 10, unevenness of the texture may cause unevenness of image transfer in electrophotographic methods. If the formation index is higher than 50, the paper has to be beaten to a higher degree in order to secure the uniformity, so that curl is intensified in some cases.

The formation index used herein refers to a value measured using a micro formation tester (MFT) and a 3-D sheet analyzer (M/K950) manufactured by M/K Systems, Inc. with analyzer diaphragm set to a diameter of 1.5 mm.

Specifically, a sample (recording sheet) is attached onto a rotatable drum of the 3-D sheet analyzer. Using a light source attached on the axis of the drum and a photodetector provided outside the drum and facing the light source, local variations in paper weight of the sample is measured in terms of variations in light intensity. The measured area is controlled by the diameter of the diaphragm provided to the incident light section of the photodetector. The variations (deviations) in light intensity are amplified, A/D converted, then classified into 64 optically measured weight classes. 1,000,000 measurements is conducted per one scanning operation and a histogram is made based on the measured values. The highest class frequency (the peak value) of the histogram is divided by the number of the classes having frequencies of 100 or more, and the obtained value (quotient) is further divided by 100. This finally obtained value is the formation index. A higher formation index indicates a better uniformity of the formation of the sheet.

When electrophotographic image formation is conducted, the electrical characteristics of the recording sheet is important. For example, when Glauber's salt or a cationized substance, which may affect the electric characteristics, is used in the preparation of the recording sheet, unevenness of image transfer may occur in electrophotographic image formation, depending on the combination and amounts of such substances.

Accordingly, the surface resistivity of the recording sheet on the side on which an image is to be formed is preferably 1.0×10⁹ to 1.0×10¹¹ Ω/sq. The volume resistivity of the recording sheet is preferably 1.0×10¹⁰ to 1.0×10¹² Ω·cm. If the surface resistivity or the volume resistivity is out of the above ranges, unevenness of the image transfer may occur in electrophotographic methods. The other side of the recording sheet may have a surface resistivity in the above range.

The surface resistivity is more preferably 5.0×10⁹ to 7.0×10¹⁰ Ω/sq, still more preferably 5.0×10⁹ to 2.0×10¹⁰ Ω/sq. The volume resistivity is more preferably 1.3×10¹⁰ to 1.6×10¹¹ Ω·cm, more preferably 1.3×10¹⁰ to 4.3×10¹⁰ Ω·cm. In this specification, the surface resistivity and the volume resistivity are values measured by the method of JIS-K-6911 after the recording sheet is left in a condition of 23° C. 50% RH for 24 hours. The disclosure of JIS-K-6911 is incorporated by reference herein.

The base paper used in the first embodiment includes pulp (cellulose pulp) as a main component. The base paper may be selected from base papers described below, or may be a plain paper obtained by treating the surface of a base paper with a substance such as a pigment or a binder.

The base paper includes cellulose pulp. As the cellulose pulp, a known pulp may be used. Specifically, chemical pulp may be used and more specifically, pulps manufactured by chemical processing of woods such as hardwood bleached kraft pulp, hardwood unbleached kraft pulp, softwood bleached kraft pulp, softwood unbleached kraft pulp, hardwood bleached sulfite pulp, hard wood unbleached sulfite pulp, softwood bleached sulfite pulp, softwood unbleached sulfite pulp and pulps manufactured by chemically processing fiber raw materials such as wood, cotton, hemp and bast may be used.

Also, for example, ground wood pulp obtained by mechanically pulping woods or chips, chemi-mechanical pulp obtained by mechanically pulping woods or chips after impregnating these woods or chips with a chemical solution, or thermo-mechanical pulp obtained by cooking chips until these chips are softened, followed by pulping by a refiner may be used. These pulps to be used may be made only of virgin pulps or waste sheet may be compounded in these pulps according to the necessity.

Particularly, pulps only containing virgin pulps are preferably pulps which are bleached by a bleaching method (Elementally Chlorine Free; ECF) using not chlorine gas but chlorine dioxide or by a method (Total Chlorine Free; TCF) using ozone/hydrogen peroxide but using no chlorine compound, or the like.

Also, as raw materials of the above waste pulps, non-printed waste sheets such as high whites, special whites, middle whites and white brokes produced through trimming or cutting or produced as brokes in book-binding factories, printing factories and cutting factories; printed fine sheets such as printed or copied fine sheets and fine coated sheets; waste sheets written, for example, with ink or in a pencil; newspaper wastes including leaflets such as printed fine sheets, coated fine sheets, middle quality sheets and coated middle quality sheets; waste sheets such as middle quality sheets, coated middle quality sheets and woody sheets may be compounded.

As the waste pulp used in the first embodiment, pulps obtained by processing the aforementioned waste sheet raw materials by at least one of ozone bleaching and hydrogen peroxide bleaching are desirable. Also, in order to obtain base sheets having a higher degree of whiteness, the ratio of the waste pulps obtained by the above bleaching treatment is preferably 50% by weight to 100% by weight. Further, the ratio of the waste pulps is more preferably 70% by weight to 100% by weight from the viewpoint of resource reutilization.

The above ozone treatment has the effect of decomposing fluorescent dyes which are usually contained in fine sheets and the hydrogen peroxide treatment has the effect of preventing yellowing caused by an alkali used in deinking treatment. It is known that the treatment which is a combination of the above two treatments not only makes it easy to carry out the deinking of waste sheets but also improves the whiteness of pulp. Also, the combined treatment has the effect of decomposing and removing residual chlorine compounds in pulp and therefore has a large effect on a reduction in the content of organic halogen compounds in waste sheets using pulp bleached with chlorine.

Also, it is preferable to add a filler to the base sheet used in the first embodiment to regulate the opaqueness, whiteness and surface characteristics. In the case of intending to reduce the amount of halogens in particular, a filler containing no halogen is preferably used. Examples of usable fillers include white inorganic pigments such as heavy calcium carbonate, light calcium carbonate, choke, kaolin, baked clay, talc, calcium sulfate, barium sulfate, titanium dioxide, zinc oxide, zinc sulfide, zinc carbonate, aluminum silicate, calcium silicate, magnesium silicate, synthetic silica, aluminum hydroxide, alumina, sericite, white carbon, saponite, calcium montmorillonite, sodium montmorillonite and bentonite and organic pigments such as acryl plastic pigments, polyethylene and urea resins. Also, when compounding waste sheets, the amount of these waste sheets must be adjusted by estimating the content of ash contained in the waste sheet raw materials in advance.

Moreover, it is preferable to add an internal sizing agent to the base sheet used in the first embodiment. As the internal sizing agent, a neutral rosin type sizing agent, alkenyl succinic acid anhydride (ASA), alkyl ketene dimer (AKD) and petroleum resin type sizing agent which are used in neutral sheet-making may be used.

When the surface of the recording sheet is controlled to be cationic, for example, a hydrophilic cationic resin or the like is used as a cationic material to treat the surface. In this case, the degree of the sheet sizing before this cationic resin is applied is preferably 10 seconds or more but less than 60 seconds in order to suppress the penetration of the cationic resin into the inside.

The recording sheet of the first embodiment can be obtained by treating the surface of the base paper as described above with a surface sizing liquid including a starch.

The surface treatment may be carried out by applying the surface sizing solution to the base paper by usual application means such as a sizing press, shim size, gate roll, roll coater, bar coater, air knife coater, rod blade coater or blade coater. The recording sheet is obtained through the subsequent drying step.

The basic weight of the recording sheet of the first embodiment is preferably in the range of 60 to 128 g/m², more preferably in the range of 60 to 100 g/m² and still more preferably in the range of 60 to 90 g/m², although no particular limitation is imposed on it. A higher basic weight is more advantageous for suppression of curl and cockle. However, if the basic weight exceeds 128 g/m², the stiffness (rigidity) of the sheet is excessively high and there is therefore a case where the sheet-running characteristics in a printer are deteriorated. On the other hand, if the basic weight is lower than 60 g/m², there is a case where it is difficult to suppress curl and cockle sufficiently. Such a low basic weight is undesirable also from the viewpoint of offset.

Also, when the sheet is made, it is preferable to adjust the fiber orientation ratio to a range of 1.0 to 1.55, more preferably 1.0 to 1.45 and still more preferably 1.0 to 1.35. When the fiber orientation ratio is within the range, the curl of the recording sheet after printing by an ink-jet system can be suppressed. The above term “fiber orientation ratio” is the fiber orientation ratio measured by a ultrasonic propagation velocity method. The ratio is a value calculated by dividing the ultrasonic propagation velocity in the MD (direction of sheet-making progress) of the sheet by the ultrasonic propagation velocity in the CD (direction perpendicular to the direction of sheet-making progress) of the sheet and is represented by the following equation (1).
Fiber orientation ratio of base sheet by a ultrasonic propagation velocity method (T/Y ratio)=(Ultrasonic propagation velocity in the MD)/(Ultrasonic propagation velocity in the CD) Equation (1)

In this case, the fiber orientation ratio measured by this ultrasonic propagation velocity method is measured using a SONIC SHEET TESTER (manufactured by Nomura Shoji (K. K.)).

The recording sheet of the first embodiment preferably includes a substance capable of stabilizing the shape of the sheet. If the recording sheet includes such a substance, covalent bonds are formed between pulp fibers whereby the dimensional change is suppressed. The substance capable of stabilizing the shape of the sheet may be, for example, an aldehyde resin, a polycarbodiimide, zirconium ammonium carbonate, or a polyvalent organic acid. The substance is preferably a polyvalent organic acid from the viewpoint of safety and cost.

The surface of the recording sheet of the first embodiment preferably includes a cationic polymer or a polyvalent metal salt. In this case, when ink-jet ink contains an anionic polymer, the anionic polymer molecules are cross-linked via the cationic polymer or polyvalent metal salt. Colorants in the ink coagulate very rapidly owing to the cross-linking, and high quality print image can be obtained. Moreover, since penetration of an ink solvent into the inside of the sheet is inhibited, curl and cockle which occur immediately after printing and curl and cockle after air drying can be suppressed further efficiently.

Examples of the aforementioned polyvalent metal salt include chlorides, formates and acetates of potassium, barium, calcium, magnesium, and other polyvalent metals. Specific examples of the polyvalent metal salt include barium chloride, calcium chloride, calcium acetate, calcium nitrate, calcium formate, magnesium chloride, magnesium sulfate, magnesium acetate, magnesium formate, and zinc chloride. Only a single kind of polyvalent metal salt may be used or plural kinds of polyvalent metal salts may be used. Among these polyvalent metals salts, metal salts with high solubilities in water and high valence numbers are preferable. In addition, if the counter ion of the polyvalent metal salt is a strong acid, yellowing of the sheet occurs after coating. Therefore, calcium chloride, calcium formate, magnesium chloride, magnesium formate and the like are preferable as the polyvalent metal salts. Examples of the cationic polymer include cationized cellulose and cationized starch; however, substances other than these substances are also included in the scope of the invention.

The above-exemplified cationic polymer or polyvalent metal salt may be incorporated into the surface of the recording sheet by adding the polymer or metal salt to the aforementioned surface sizing solution or by applying another coating solution containing the polymer or metal salt to the surface of the base paper. In the latter case, the coating may be carried out by dissolving the polymer or metal salt in water to form a coating solution and applying the coating solution directly to the recording sheet (or a sheet). However, generally, a binder is also included in the coating solution.

The content of the cationic polymer and polyvalent metal salt contained in the surface of the recording sheet is preferably in the range of 0.1 to 2.0 g/m² and more preferably in the range of 0.5 to 1.0 g/m².

If the content is less than 0.1 g/m², the degree of the reaction with pigments and anionic polymers contained in ink is low and image quality is likely to be low, curl and cockle immediately after printing are likely to be heavy, and curl and cockle after air drying are likely to be also heavy. On the other hand, if the content exceeds 2.0 g/m², the penetration of ink is impaired and ink-drying properties are likely to be impaired in high-speed printing.

(Electrophotographic Image Recording Method)

The electrophotographic image recording method in the first embodiment comprises: charging the surface of an electrostatic latent image holding member; exposing the surface of the electrostatic latent image holding member to form an electrostatic latent image; developing the electrostatic latent image on the surface of the electrostatic latent image holding member by using a developer to form a toner image; transferring the toner image to the surface of a recording sheet; and fixing the toner image on the surface of the recording sheet, wherein the recording sheet is the aforementioned recording sheet of the first embodiment.

According to the electrophotographic image recording method of the first embodiment, curl which occurs immediately after printing can be suppressed.

Any device may be used as the image forming device used in the electrophotographic image recording method of the first embodimennt insofar as it utilizes an electrophotographic system involving the above charging step, exposure step, developing step, transfer step and fixing step. In the case of using, for example, four color toners including a cyan, a magenta, a yellow and a black toner, the device may be a color image forming device using a 4-cycle developing system in which developing agents each including a toner of a different color are provided sequentially to a light-sensitive body to form a toner image, a color image forming device (so-called tandem machine) provided with four developing units corresponding to respective colors, or the like.

As the toner for forming image, any known toners may be used without any particular limitation. However, for example, spherical toners having a small particle diameter and narrow particle size distribution may be used so as to obtain a highly precise image and toners containing a binder resin with a low melting point may be used in order to enable low-temperature fixation.

(Ink-Jet Image Recording Method)

The ink-jet image recording method of the first embodiment comprises recording an image on a recording sheet by providing ink droplets onto the recording sheet, wherein the recording sheet is the recording sheet of the first embodiment. Therefore, the ink-jet image recording method suppresses the curl immediately after printing and the curl after air drying.

The ink-jet recording method of the first embodiment may be conducted by conventional ink-jet recording apparatuss such as thermal ink-jet recording apparatuses and piezo ink-jet recording apparatuses. The ink-jet recording method may be applied to a system having a means for heating a recording sheet during printing, before printing, or after printing, the means being capable of promoting the absorption and fixing of ink by heating the recording sheet and ink to 50° C. to 200° C.

Next, an example of an ink-jet recording device is described which is suitable for practicing the ink-jet recording method of the first embodiment. This example is called a multi-pass system, in which the recording head is allowed to scan the surface of a recording sheet several times to form an image.

As a system which discharges ink from a nozzle, a so-called thermal ink-jet system is exemplified in which power is supplied to a heater disposed in a nozzle to foam ink in the nozzle so that the ink is discharged by the pressure generated by the foam. There is also a system in which power is supplied to a piezoelectric element to deform the piezoelectric element physically so that the force generated by the deformation is used for discharging ink from a nozzle.

This system typically uses a piezo element as the piezoelectric element. In an ink-jet recording device used in the ink-jet recording method of the first embodiment, the system for discharging ink from a nozzle may be any of the aforementioned systems and is not limited to these systems. The system is not limited throughout the specification.

Second Embodiment:

Recording Sheet

In a second embodiment, the invention provides a recording sheet. The recording sheet is a plain paper including a base paper including a pulp fiber and a filler as main components, wherein the plain paper does not have a coated layer including pigments and the plain paper has been coated with a processing liquid including a starch. The recording sheet is such a recording sheet that when 0.06 m² of the recording sheet is subjected to hot water extraction, the solid amount of the extract is 0.01 to 0.4 g and the carboxyl group content in the solid is 0 to 5 meq/100 g.

In an embodiment, the processing liquid includes a di- or higher-valent metal salt, and in a condition of 23° C. 50% RH, the recording sheet has a ratio of surface electric resistivity to volume electric resistivity in the range of 0.1 to 1, a surface electric resistivity of 1.0×10⁹ to 1.0×10¹¹ Ω/sq, and a volume electric resistivity of 5.0×10⁹ to 5.0×10¹¹ Ω·cm.

The recording sheet of the second embodiment is a plain paper not having a coated layer including a pigment. Therefore, the processing liquid is preferably practically free from pigments. The term “practically free from pigments” used herein refers to that the content of pigments in the processing liquid is 10 weight % or lower.

Examples of the starch used in the second embodiment is described later. Starch is a natural water-soluble polymer having a small amount of carboxyl groups. Before starch is used for surface treatment of the sheet, the starch is usually subjected to a treatment which decreases the viscosity of the starch so as to improve the efficiency of the surface treatment. Such a treatment for decreasing the viscosity is generally a treatment which reduces the molecular weight of the starch, such as an oxidation treatment or an enzymatic modification treatment. By the treatment which reduces the molecular weight of the starch, the number of carboxyl groups is likely to increase.

Although the reason is not apparent, the curl after thermal fixing is clearly suppressed in electrophotographic recording methods if a starch having fewer carboxyl groups is used in the recording sheet. Similarly, when starches having different amount of carboxyl groups are mixed and used, the curl after thermal fixing is suppressed by use of a combination of starches having smaller amounts of carboxyl groups.

From this observation, the inventors have found that the curl after thermal fixing can be suppressed if the solid obtained by hot water extraction of a recording sheet treated with a starch has a carboxyl group content of 0 to 5 meq/100 g.

Colorants in water-soluble inks used in ink-jet recording methods are generally anionic. If there is a substance on the surface of a recording sheet which substance has the same ionic polarity as the colorants in the ink, the colorants are repelled by the region having the substance. The repulsion develops undesirable white dots in the solid image region which should have a solid image with uniform color and the white dots reduces the color rendition. The inventors have thought that it is not preferable for the starch used on the sheet surface to have such characteristics as to deteriorate the image quality.

If the solid obtained by hot water extraction of a recording sheet treated with a starch has a carboxyl group content of 0 to 5 meq/100 g, the amount of the component which hydrates in the ink and repels the anionic colorant in the ink is reduced, whereby the color rendition is improved. Further, the inventors have also found that the amount of the component which hydrates in the ink and fix the colorant is appropriate if the condition “when 0.06 m² of the recording sheet is subjected to hot water extraction, the solid amount of the extract is 0.01 to 0.4 g” is satisfied.

If the amount of the component is small which hydrates in the ink when the ink is provided on to the sheet surface, the colorant is not fixed and penetrates into the interior of the paper or spreads randomly on the thick layer of the scarcely hydratable substance, resulting in deterioration of uniform color rendition. If the amount of the component is too large, the molecular weight of the starch is too small and there is no polymer compound which fix the complex or insolubilized matter formed by the combination of the colorant and the hydrated component, thus degrading the color rendition.

The carboxyl group content in the solid obtained by the hot water extraction is preferably 0 to 5 meq/100 g, more preferably 0 to 3 meq/100 g. This is because the curl after thermal fixing in electrophotographic methods is more suppressed if the carboxyl group content is lower and the color rendition in ink-jet methods is improved if the content of carboxyl group which repel the colorant is lower.

As described above, the advantageous effect can be obtained by limiting the amount and carboxyl content of the solid obtained by the hot water extraction of the sheet.

If the surface of the sheet is further treated with a polyvalent metal salt, the color rendition in ink-jet recording methods is improved. However, if a large amount of a cationic polyvalent metal salt is used for the surface treatment, the toner transferability in electrophotographic methods is likely to be deteriorated.

Therefore, it is important for the transferability in electrophotographic recording methods and the color rendition in ink-jet recording methods that the polyvalent metal salt applied to the surface of the surface of the sheet remain in the neighborhood of the surface. Therefore, the inventors have focused on the surface electric resistivity and volume electric resistivity as indexes reflecting the distribution of ionic substances.

In a preferable embodiment, in a condition of 23° C. 50% RH, the recording sheet has a ratio of surface electric resistivity to volume electric resistivity in the range of 0.1 to 1, a surface electric resistivity of 1.0×10⁹ to 1.0×10¹¹ Ω/sq, and a volume electric resistivity of 5.0×10⁹ to 5.0×10¹¹ Ω·cm. In this specification, the ratio of surface electric resistivity to volume electric resistivity refers to the value (surface electric resistivity (Ω/sq)/volume electric resistivity (Ω·cm)). The ratio is preferably in the range of 0.1 to 1, more preferably in the range of 0.1 to 0.5. If the ratio is lower than 0.1, the volume electric resistivity is too high relative to the surface electric resistivity; therefore an excessive charge remains in the sheet in the electrophotographic printing, whereby discharge occurs when the sheet is removed from the transfer member, thus causing image quality defect. If the ratio is higher than 1, the volume electric resistivity is too low; this indicates that the cationic polyvalent metal salt applied to the surface has penetrated into the interior of the sheet in a large amount and does not remain in the neighborhood of the surface. In this case, the color rendition upon ink-jet printing is hardly improved. Further, also in electrophotographic methods, the charge does not remain on the surface and leaks to the back side to cause transfer defect.

The surface resistivity on the printing face of the recording sheet of the second embodiment is preferably 1.0×10⁹ to 1.0×10¹¹ Ω/sq, more preferably 5.0×10⁹ to 7.0×10¹⁰ Ω/sq, still more preferably 5.0×10⁹ to 2.0×10¹⁰ Ω/sq. The term “printing face” used herein refers to the face which has been treated with a starch and a polyvalent metal salt.

The volume resistivity is preferably 1.0×10¹⁰ to 1.0×10¹² Ω·cm, more preferably 1.3×10¹⁰ to 1.6×10¹¹ Ω·cm, more preferably 1.3×10¹⁰ to 4.3×10¹⁰ Ω·cm.

The recording sheet which does not have transfer problems in electrophotographic recording methods and which exhibits improved color rendition in ink-jet recording methods can be obtained by applying a processing liquid including a polyvalent metal salt such that the surface electric resistivity, the volume electric resistivity, and the ratio of surface electric resistivity to volume electric resistivity are within the above ranges respectively.

The base paper used for the preparation of the recording sheet of the second embodiment is described below. The base paper used in the recording sheet includes a pulp fiber and a filler as main component.

The pulp fiber may be a chemical pulp fiber. Examples of the chemical pulp include pulps manufactured by chemical processing of woods such as hardwood bleached kraft pulp, hardwood unbleached kraft pulp, softwood bleached kraft pulp, softwood unbleached kraft pulp, hardwood bleached sulfite pulp, hard wood unbleached sulfite pulp, softwood bleached sulfite pulp, softwood unbleached sulfite pulp and pulps manufactured by chemically processing fiber raw materials such as wood, cotton, hemp and bast.

Also, for example, ground wood pulp obtained by mechanically pulping woods or chips, chemi-mechanical pulp obtained by mechanically pulping woods or chips after impregnating these woods or chips with a chemical solution, or thermo-mechanical pulp obtained by cooking chips until these chips are softened, followed by pulping by a refiner may be used. The thermo-mechanical pulp may be a chemi-thermo-mechanical pulp which enables a high yield. These pulps to be used may be made only of virgin pulps or waste sheet may be compounded in these pulps according to the necessity.

Particularly, the virgin pulps are preferably pulps which are bleached by a bleaching method (Elementally Chlorine Free; ECF) using not chlorine gas but chlorine dioxide or by a method (Total Chlorine Free; TCF) using ozone/hydrogen peroxide but using no chlorine compound, or the like.

Also, as raw materials of the above waste pulps, non-printed waste sheets such as high whites, special whites, middle whites and white brokes produced through trimming or cutting or produced as brokes in book-binding factories, printing factories and cutting factories; printed fine sheets such as printed or copied fine sheets and fine coated sheets; waste sheets written, for example, with ink or in a pencil; newspaper wastes including leaflets such as printed fine sheets, coated fine sheets, middle quality sheets and coated middle quality sheets; waste sheets such as middle quality sheets, coated middle quality sheets and woody sheets may be compounded.

As the waste pulp used in the second embodiment, pulps obtained by processing the aforementioned waste sheet raw materials by at least one of ozone bleaching and hydrogen peroxide bleaching are desirable. Also, in order to obtain base sheets having a higher degree of whiteness, the ratio of the waste pulps obtained by the above bleaching treatment is preferably 50% by weight to 100% by weight. Further, the ratio of the waste pulps is more preferably 70% by weight to 100% by weight from the viewpoint of resource reutilization.

The above ozone treatment has the effect of decomposing fluorescent dyes which are usually contained in fine sheets and the hydrogen peroxide treatment has the effect of preventing yellowing caused by an alkali used in deinking treatment. It is known that the treatment which is a combination of the above two treatments not only makes it easy to carry out the deinking of waste sheets but also improves the whiteness of pulp. Also, the combined treatment has the effect of decomposing and removing residual chlorine compounds in pulp and therefore has a large effect on a reduction in the content of organic halogen compounds in waste sheets using pulp bleached with chlorine.

Also, a filler is added to the base sheet used in the second embodiment to regulate the opaqueness, whiteness and surface characteristics. In the case of intending to reduce the amount of halogens in particular, a filler containing no halogen is preferably used. Examples of usable fillers include white inorganic pigments such as heavy calcium carbonate, light calcium carbonate, choke, kaolin, baked clay, talc, calcium sulfate, barium sulfate, titanium dioxide, zinc oxide, zinc sulfide, zinc carbonate, aluminum silicate, calcium silicate, magnesium silicate, synthetic silica, aluminum hydroxide, alumina, sericite, white carbon, saponite, dolomite, calcium montmorillonite, sodium montmorillonite and bentonite and organic pigments such as acryl plastic pigments, polyethylene, chitosan particles, cellulose particles, polyamino acid particles, and urea resins.

Also, when compounding waste sheets, the amount of these waste sheets must be adjusted by estimating the content of ash contained in the waste sheet raw materials in advance.

The amount of the filler to be blended is not particularly limited. The amount of the filler is preferably 1 to 80 parts by mass based on 100 parts of the pulp fiber, and more preferably 1 to 50 parts by mass based on 100 parts of the pulp fiber.

Also, when the sheet is made, it is preferable to adjust the fiber orientation ratio to the range of 1.0 to 1.55, preferably of 1.0 to 1.45 and more preferably of 1.0 to 1.35. When the fiber orientation ratio is within the range of 1.0 to 1.55, the curl of the recording sheet after printing can be suppressed in both of an electrophotographic recording method and an ink-jet recording method. The meaning of the fiber orientation ratio is explained in the description of the first embodiment.

Starch

The starch used in the second embodiment will be explained.

The scope of the starch used in the second embodiment includes starches extracted from polysaccharides synthesized by plants through photosynthesis reactions and products obtained by processing the starches derived from natural sources. Examples of the starch include: non-modified starches such as tapioca starch, Irish potato starch, corn starch, waxy starch, and sugarcane starch; and modified starches such as cationized starches, oxidized starches, anionized starches, enzymatically-modified starches, and starches to which hydrophobic groups are incorporated. An enzymatically-modified starch obtained by cleaving α-glycoside bonds by an enzyme is preferable since carboxyl groups are hardly generated. In the case of oxidized starches, a lot of carboxyl groups are generated by a wet treatment with sodium hypochlorite, which is usually used for oxidization; however, when a starch in the form of powder is oxidized with a periodate or the like in a dry manner, the oxidation is mild and the oxidized portion remains in an aldehyde form to give dialdehyde starch or the like, wherein the mild oxidation is preferred since the generation of carboxyl groups is suppressed. In wet methods, the oxidation can be made mild by maintaining a high reaction pH; an oxidized starch having few carboxyl groups can be obtained by a short-time high-pH treatment. However, even in the case, the carboxyl group content of the starch oxidized by a wet method is higher than that of enzymatically-modified starch and higher than that of the starch oxidized by a dry method. Accordingly, the starch having few carboxyl groups is preferably an enzymatically-modified starch or a starch obtained by a dry oxidation treatment. In order to satisfy the condition “the solid obtained by hot water extraction has a carboxyl group content of 0 to 5 meq/100 g”, the starch is preferably a starch having low carboxyl content. The carboxyl content of the starch is preferably 0 to 5 meq/100 g, more preferably 0 to 4 meq/100 g, still more preferably 0 to 3 meq/100 g. When the IR absorption spectrum of the solid obtained by hot water extraction is confirmed, absorption unique to starch ranging from 950 to 1150 cm⁻¹ is observable with three peaks in the neighborhood of 1153 cm⁻¹, 1078 cm⁻¹, and 1024 cm⁻¹.

Metal Salt

Next, the metal salt used in the second embodiment will be explained. The metal salt is a metal salt which becomes cationic when dissolved in pure water. In an embodiment, at least one metal salt including a di- or higher-valent metal ion is used.

The metal salt including a di- or higher-valent metal ion may be a known metal salt. The di- or higher-valent metal salt is preferably selected from: ions of aliminum, berylium, calcium, magnesium, strontium, barium, radium, and zinc; Fe(II) ion; and Fe(III) ion. Calcium ion and magnesium ion are more preferred.

These metal ions have small molecular weights, and can dissolve easily in the ink provided onto the recording sheet. Further, the time required for hydration upon ionization is short, whereby these ions can insolubilize and/or aggregate the colorant having the opposite ionic polarity to the metal ions.

Preparation of Recording Sheet and Characteristics Thereof

Next, the method for preparing the recording sheet of the second embodiment and preferable characteristics of the recording sheet will be explained.

The method for coating the surface of the base paper with a processing liquid including a starch and a metal salt is not particularly limited. Usually, the processing liquid is used as a coating liquid (size press liquid), and the surface of the base sheet is preferably subjected to a size press treatment with the processing liquid.

As described above, the processing liquid is preferably practically free from pigments (which means that the pigment content in the processing liquid is 10 weight % or lower). In other words, the recording sheet of the second embodiment which has been subjected to a surface treatment is a plain paper not having a coated layer containing a pigment. Such a coated layer containing a pigment is used in coated paper, which is different from the recording sheet of the second embodiment. The coated paper having a coated layer containing a pigment is excluded from the scope of the second embodiment since the coated sheet has problems of cost, damage on transfer members, and paper dust when used as recording sheets for electrophotographic recording or ink-jet recording in usual offices.

The coating liquid can be coated on the surface of the base paper by usual application means such as a sizing press, shim size, gate roll, roll coater, bar coater, air knife coater, rod blade coater or blade coater. The base paper coated with a processing liquid including a starch and a metal salt is dried to give the recording sheet of the second embodiment.

When the surface of the base paper is coated with a processing liquid including a starch and a metal salt, the amount of the processing liquid per one side of the base paper is 0.4 to 6 g/m² in terms of solid amount, more preferably 0.5 to 3 g/m² in terms of solid amount. The weight ratio of starch to metal salt in the processing liquid is preferably in the range of ⅕ to 5/0.1, more preferably ⅔ to 5/1.

If the solid amount of the starch or the solid amount of the metal salt is smaller than 0.1 g/m², the effect of the surface sizing treatment cannot be obtained, the effect being improving the strength of the surface. If the solid amount is larger than 5 g/m², the texture of the recording sheet is unlikely to be suitable for plain paper. Therefore, the total solid amount of the starch and metal salt to be applied to the surface is preferably 0.6 to 5 g/m².

The sizing degree of the recording sheet of the second embodiment can be adjusted to a suitable value by controlling the amount and kind of starch, the amounts and kinds of other water-soluble polymers, and the like. If a desired sizing degree cannot be obtained by controlling those factors, a surface sizing agent may be further added. The surface sizing agent may be, for example, a rosin sizing agent, a synthetic sizing agent, a petroleum resin sizing agent, a neutral sizing agent, or a polyvinylalcohol.

The sizing degree can be controlled during the papermaking by adding an internal sizing agent in the slurry preparation step in the papermaking. Surface sizing agents and internal sizing agents free of halogen are preferable when smaller amount of halogen in the recording sheet is preferred. Such a sizing agent may be a rosin sizing agent, a synthetic sizing agent, a petroleum resin sizing agent, or a neutral sizing agent.

A combination of a sizing agent and a fixing agent for fiber may be used. In this case, the fixing agent may be, for example, aluminum sulfate or a cationized starch. The sizing agent is preferably a neutral sizing agent from the viewpoint of the improvement of storability of recording sheets. The sizing degree can be controlled by the amount of the sizing agent to be added.

The recording sheet has a stöckigt sizing degree of preferably 10 to 60 seconds, more preferably 15 to 30 seconds. If the stöckigt sizing degree is less than 10 seconds: in ink-jet printing, feathering deteriorates and small letters are likely to be unable to read; and when bar-code or the like is ink-jet printed, the bar-code is likely to be unable to read. Therefore, the stöckigt sizing degree below 10 seconds may deteriorate practical utility.

If stöckigt sizing degree is more than 60 seconds, toner fixability may deteriorate in electrophotographic printing.

The stöckigt sizing degree is defined in JIS P8122:1976 (the disclosure of which is incorporated by reference herein) measured in the standard environment (23° C. 50% RH) defined in JIS P8111:1988 (the disclosure of which is incorporated by reference herein).

The smoothness of the recording sheet is preferably 20 to 100 seconds, more preferably 70 to 100 seconds, from the viewpoint of improving toner transferability and graininess. If the smoothness is lower than 20 seconds, the graininess may deteriorate. If the smoothness is higher than 100 seconds, high pressure pressing in a wet state during the production is required for obtaining the high smoothness; the high pressure pressing may result in increase in transparency of the sheet or severer curl after thermal fixing. In this specification, the smoothness refers to the value measured by the method defined in JIS-P-8119:1998, the disclosure of which is incorporated by reference herein.

The recording sheet has a formation index of preferably 20 or higher, more preferably 30 or higher, from the viewpoint of suppressing development of cloud-like mottle in electrophotographic image formation. If the formation index is lower than 20, in electrophotographic recording, toner tends to penetrate into the recording sheet unevenly in thermal fusing, whereby mottle develops to deteriorate the image quality. The method for measuring the formation index is explained in the description of the first embodiment.

When the recording sheet of the second embodiment is used as a recording medium for electrophotography, thermal transfer, or a combination thereof, it is preferable to control the surface electric resistivity of the recording sheet by adding a conductive agent. The conductive agent is preferably a conductive agent free of halogen, in order to reduce the halogen amount in the recording sheet.

Examples of the conductive agent include: inorganic electrolytes such as sodium sulfate, sodium carbonate, lithium carbonate, sodium methasilicate, sodium tripolyphosphate, and sodium methaphosphate; anionic surfactants such as sulfonates, sulfuric ester salts, carboxylates, and phosphates; cationic surfactants; nonionic surfactants and amphoteric surfactants such as polyethylene glycol, glycerine, and sorbit; and polymer electrolytes. As described above, a di- or higher-valent metal salt is preferably used in the second embodiment in particular, and use of the metal salt can improve the color rendition in ink-jet printing.

The air permeability of the sheet before coated with the processing liquid including a starch and a metal salt is preferably 10 to 30 seconds. The air permeability can be controlled, for example by subjecting the base paper to a calendering treatment. By increasing the air permeability, the penetration of the processing liquid into the recording sheet is suppressed when the suface of the base paper is coated with the processing liquid including a starch and a metal salt. However, if the air permeability is excessively high, the penetration of ink in ink-jet printing is also inhibited, whereby intercolor bleed may occur and drying property may deteriorate. Accordingly, the air permeability is preferably adjusted in consideration of such problems.

The penetration of the processing liquid into the base paper can be suppressed by size pressing the base paper which has been dried without subjected to size pressing.

(Electrophotographic Image Recording Method)

The electrophotographic image recording method in the second embodiment comprises: charging the surface of an electrostatic latent image holding member; exposing the surface of the electrostatic latent image holding member to form an electrostatic latent image; developing the electrostatic latent image on the surface of the electrostatic latent image holding member by using a developer to form a toner image; transferring the toner image to the surface of a recording sheet; and fixing the toner image on the surface of the recording sheet, wherein the recording sheet is the aforementioned recording sheet of the second embodiment.

According to the electrophotographic image recording method of the second embodiment, curl which occurs after thermal fixing can be greatly suppressed, while the image quality is maintained as high as in conventional methods.

Any device may be used as the image forming device used in the electrophotographic image recording method of the second embodimennt insofar as it utilizes an electrophotographic system involving the above charging step, exposure step, developing step, transfer step and fixing step. In the case of using, for example, four color toners including a cyan, a magenta, a yellow and a black toner, the device may be a color image forming device using a 4-cycle developing system in which developing agents each including a toner of a different color are provided sequentially to a light-sensitive body to form a toner image, a color image forming device (so-called tandem machine) provided with four developing units corresponding to respective colors, or the like.

As the toner for forming image, any known toners may be used without any particular limitation. For example, spherical toners having a small particle diameter and narrow particle size distribution may be used so as to obtain a highly precise image and toners containing a binder resin with a low melting point may be used in order to enable low-temperature fixation which is preferable from the viewpoint of energy-saving.

(Ink-Jet Image Recording Method)

Next, the ink-jet image recording method of the second embodiment (occasionally called “ink-jet recording method” hereinafter) will be explained. The ink-jet image recording method of the second embodiment comprises recording an image on a recording sheet by using ink. The ink is not particularly limited and may be selected from known inks. The ink is preferably an ink including water and a colorant.

Examples of the colorant include dyes, hydrophobic pigments used in combination with pigment dispersants containing hydrophilic groups which enable the hydrophobic pigments to be dispersed in ink, and self-dispersible pigments. The solvent may be water or a known water-soluble organic solvent. The solvent may include additives such as surfactants in accordance with the necessity.

When the recording sheet is used for ink-jet printing, the amount of ink jetted from the nozzle per one drop is preferably 1 to 20 pl, more preferably 3 to 18 pl.

The ink-jet recording method of the second embodiment realizes excellent printing quality when used for printing with any known ink-jet instrument, regardless of the specific manner of ink-jet recording. The ink-jet recording method may be applied to a system having a means for heating a recording sheet during printing, before printing, or after printing, the means being capable of promoting the absorption and fixing of ink by heating the recording sheet and ink to 50° C. to 200° C.

As a method for discharging ink from a nozzle, a so-called thermal ink-jet system is exemplified in which power is supplied to a heater disposed in a nozzle to foam ink in the nozzle so that the ink is discharged by the pressure generated by the foam. There is also a system in which power is supplied to a piezoelectric element to deform the piezoelectric element physically so that the force generated by the deformation is used for discharging ink from a nozzle. This system typically uses a piezo element as the piezoelectric element. In an ink-jet recording device used in the ink-jet recording method of the second embodiment, the system for discharging ink from a nozzle may be any of the aforementioned systems but is not limited to these systems.

Although, the headings “first embodiment” and “second embodiment” are used in the description, the features of each embodiment may be freely combined with the features of the other embodiment. Therefore, the scope of the invention includes combination of the embodiments described in the specification.

### EXAMPLES

In the following, the present invention will be explained more specifically with reference to Examples and Comparative examples. However, the Examples should not be construed as limiting the invention.

### Example 1

Preparation of Recording Sheet

(Recording Sheet 1)

Dry pulp made of hardwood kraft pulp is defiberized and subjected to refining such that the freeness becomes 420 ml. Then, a pulp dispersion liquid is prepared such that the pulp solid content is 0.3% by mass.

To the pulp dispersion liquid containing 100 parts by mass of pulp solid, 0.3 part by mass of anhydrous succinic acid (ASA) internal sizing agent (FIBRAN-81, manufactured by Nippon NSC, Ltd.) and 0.5 part by mass of a cationized starch (CATO-304, manufactured by Nippon NSC, Ltd.) are added. The mixture is subjected to papermaking with 80 mesh wire by an fiber-orienting paper machine for experiment use manufactured by Kumagai Riki Kogyo Co., Ltd. (K. K.) in the following condition: papermaking speed: 1000 m/min and paper discharge pressure: 1.5 kg/cm².

Thereafter, this set is pressed under a pressure of 10 kg/cm² for 3 minutes by an rectangular press for paper machine manufactured by Kumagai Riki Kogyo Co., Ltd. and is dried at 120° C. in the condition of 0.5 m/min by a KRK rotary type drier manufactured by Kumagai Riki Kogyo Co., Ltd. to obtain base paper having a basic weight of 68 g/m².

A surface sizing liquid is prepared as follows. A container containing a solution including 8 weight % of a corn starch (Corn starch Y, manufactured by Nihon Shokuhin Kako Co., Ltd.) is put in a boiling hot water bath and left for 30 minutes so as to gelatinize the starch. Then, the container is put in a water bath of 40° C. and left for one hour to age the solution. Then, an enzyme (α-amylase manufactured by Daiwa Kasei K. K.) is added to the starch solution in an amount of 0.3 weight % of the dry weight of the unmodified starch in the starch solution, and the starch solution is stirred for 1 minute. Subsequently, the container is put in a boiling hot water bath and left for 10 minutes to inactivate the enzyme. Then, the container is cooled to 23° C. to give a starch A, which is an enzymatically-modified starch F.

A 8 weight % aqueous solution (surface sizing liquid) containing the starch A and Glauber's salt is prepared. In the solution, the weight of the solid amount of the starch A is 10 times the weight of Glauber's salt. The solution is heated to 50° C. and used for size-pressing the obtained base paper by a testing size press manufactured by Kumagai Riki Kogyo Co., Ltd., such that the amount of solids applied to the base paper is 2 g/m². Then, the base paper is dried at 120° C. in the condition of 0.5 m/min by a KRK rotary type drier manufactured by Kumagai Riki Kogyo Co., Ltd. to obtain a recording sheet (1) having a basic weight of 70 g/m².

(Recording Sheet 2)

A starch B, which is an enzymatically-modified starch F, is obtained in the same manner as in the preparation of the starch A, except that the amount of the enzyme is changed to 0.10 weight % of the dry weight of the unmodified starch. A recording sheet (2) is obtained in the same manner as in the preparation of the recording sheet (1), except that the starch B is used in place of the starch A. The recording sheet (2) has a basic weight of 70 g/m².

(Recording Sheet 3)

Pulp made of 3 parts by mass of dry hardwood kraft pulp and 7 parts by mass of waste middle quality sheet is defiberized and subjected to refining such that the freeness becomes 350 ml. Then, a pulp dispersion liquid is prepared such that the pulp solid content is 0.3% by mass. A recording sheet (3) is obtained in the same manner as in the preparation of the recording sheet (1), except that the pulp dispersion liquid is changed to the pulp dispersion liquid obtained above. The recording sheet (2) has a basic weight of 70 g/m².

(Recording Sheet 4)

A starch C, which is an enzymatically-modified starch F, is obtained in the same manner as in the preparation of starch A, except that the amount of the enzyme is changed to 0.03 weight % of the dry weight of the unmodified starch. A recording sheet (4) is obtained in the same manner as in the preparation of the recording sheet (1), except that the starch C is used in place of the starch A. The recording sheet (4) has a basic weight of 70 g/m².

(Recording Sheet 5)

A recording sheet (5) is obtained in the same manner as in the preparation of the recording sheet (1), except that the commercially available enzymatically-modified starch (HI-COASTER, manufactured by Sanwa Cornstarch Co., Ltd.) as a surface sizing agent is used in place of the starch A. The recording sheet (5) has a basic weight of 70 g/m².

(Recording Sheet 6)

A recording sheet (6) is obtained in the same manner as in the preparation of the recording sheet (1), except that the commercially available oxidized starch (ACE A, manufactured by Oji Cornstarch Co., Ltd.) as a surface sizing agent is used in place of the starch A. The recording sheet (6) has a basic weight of 70 g/m².

(Recording Sheet 7)

A recording sheet (7) is obtained in the same manner as in the preparation of the recording sheet (1), except that the unprocessed starch (Corn starch Y, manufactured by Nihon Shokuhin Kako Co., Ltd.) as a surface sizing agent, which is the starting raw material of the starch A, is used in place of the starch A. The recording sheet (7) has a basic weight of 70 g/m².

(Recording Sheet 8)

A recording sheet (8) is obtained in the same manner as in the preparation of the recording sheet (1), except that an oxidized starch prepared by dry oxidation (oxidized starch prepared by dry oxidation, manufactured by Oji Cornstarch Co., Ltd.) as a surface sizing agent is used as it is, in place of the starch A. The recording sheet (8) has a basic weight of 70 g/m².

(Recording Sheet 9)

A starch D, which is an enzymatically-modified starch F, is obtained in the same manner as in the preparation of starch A, except that the raw material for starch is changed from corn starch to wheat starch. A recording sheet (9) is obtained in the same manner as in the preparation of the recording sheet (1), except that the starch D is used in place of the starch A. The recording sheet (9) has a basic weight of 70 g/m².

The preparation conditions (constitution) of the recording sheets are shown in Table 1. The properties of the recording sheets such as reflection density are shown in Table 2.

[image]

[image]

<Evaluation>

The recording sheets are used for electrophotographic image formation and ink-jet image formation. The curl after the image formation is evaluated. The evaluation of the recording sheets are conducted in the following manner. The results of the evaluation are shown in Table 3.

(1) Evaluation of Curl in Electrophotographic Recording

The recording sheets (1) to (9) are left in an environment of 23° C. 65% RH for 12 hours so as to control the moisture content. The felt side of the recording sheet refers to the side opposite to the side which is dehydrated in papermaking. Using the felt side surfaces of the recording sheets as image forming surface, the recording sheets are used for one-sided copy by a DOCUPRINT 260 manufactured by Fuji Xerox Printing Systems Co., Ltd., then the height of the curl is evaluated.

The recording sheets are cut into B5 (182 mm×257 mm) sized pieces such that the MD (the direction of paper-making progress) is the longitudinal direction. Using a white sheet without image as the original sheet to be copied, the B5-sized recording sheets are used for one-sided copy as described above. Since the white sheet is used as the original sheet to be copied, no image is formed on the B5-sized recording sheets. The curl height h of each recording sheet is evaluated with the following evaluation criterion. Only the ranks A and B are at acceptable levels.

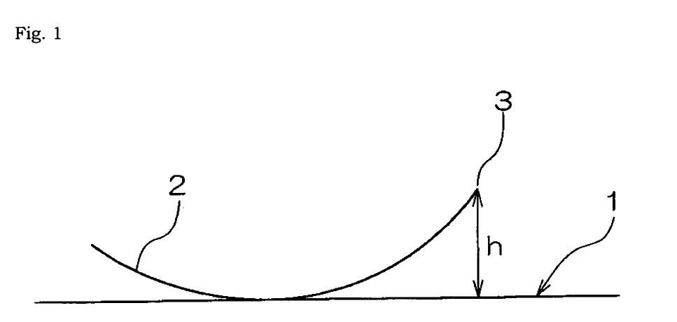

The curl height h is illustrated in FIG. 1. As shown in FIG. 1, the curl height h refers to the length of the longest line which connects a point on the plane 1 and a point on the edge 3 of the recording sheet 2 and which is perpendicular to the plane 1, wherein the recording sheet 2 is a recording sheet after thermal fixing, and the recording sheet 2 is placed on the plane 1.
Rank A: h<45 mm
Rank B: 45 mm≦h<55 mm
Rank C: h≧55 mm
   (2) Evaluation of Curl in Ink-Jet Recording
   Evaluation of Curl Immediately After Printing

The recording sheet are cut into postcard sized (100 mm×148 mm) pieces. A magenta 100% solid image (amount of applied ink: 10 g/m²) is printed on one side of each postcard sized recording sheet (with a margin of 5 mm) by an ink-jet recording apparatus (N2100, manufactured by Canon Inc.). The degree of hanging curl occurring on the other side than the printed side immediately after the printing is measured and the measured value is converted to curvature. The curvature is evaluated using the following criterion. Only the ranks A and B are at acceptable levels.
Rank A: lower than 35 m⁻¹
Rank B: 35 m⁻¹ to 50 m⁻¹
Rank C: higher than 50 m⁻¹
   Evaluation of Curve After Air Drying

The recording sheet are cut into postcard sized (100 mm×148 mm) pieces. A magenta 100% solid image (amount of applied ink: 10 g/m²) is printed on one side of each postcard sized recording sheet (with a margin of 5 mm) by an ink-jet recording apparatus (N2100, manufactured by Canon Inc.). The recording sheets are laid flat with the printed surface facing upward and left in a condition of 23° C. 50% RH. After leaving the sheets in the condition for 100 hours, the degree of the hanging curl is measured and the measured value is converted to curvature. The curvature is evaluated using the following criterion. Only the ranks A and B are at acceptable levels.
Rank A: lower than 30 m⁻¹
Rank B: 30 m⁻¹ to 75 m⁻¹
Rank C: higher than 75 m⁻¹

The results are shown in Table 3 below.

TABLE 3

| | Evaluation Results | | | |
|---|---|---|---|---|
| | Electrophoto | Ink-jet recording | | |
| | grahic | Curl | Curl | |
| Recording | recording | immediately | after air | |
| sheet No. | Curl height | after printing | drying | Remarks |
| 1 | A | A | A | Invention |
| 2 | A | A | A | Invention |
| 3 | B | B | B | Invention |
| 4 | B | B | B | Invention |
| 5 | C | C | C | Comp. ex. |
| 6 | C | C | C | Comp. ex. |
| 7 | C | C | C | Comp. ex. |
| 8 | C | C | C | Comp. ex. |
| 9 | A | A | A | Invention |

### Example 2

Hardwood kraft pulp is subjected to the ECF multi-step bleaching comprising oxygen bleaching, alkaline extraction, and gas phase chlorine dioxide treatment. The bleached pulp is refined such that the freeness becomes 450 ml. 100 parts by mass of the obtained pulp is mixed with 10 parts by mass of bentonite filler, 10 parts by mass of light calcium carbonate filler, and 0.1 part by mass of alkylketene dimer (AKD) internal sizing agent, and the mixture is subjected to papermaking.

Separately, a coating liquid (as a surface sizing liquid) containing 88 parts by mass of water, 6 parts by mass of sodium chloride, and 6 parts by mass of an enzymatically-modified starch by treating commercially available cornstarch with α-amylase is prepared. The sheet obtained above is subjected to a size pressing with the coating liquid, so that a recording sheet having a basic weight of 64 g/m² is obtained, wherein the surface of the recording sheet has 1.0 g/m² of sodium chloride and 1.0 g/m² of the enzymatically-modified starch.

### Example 3

Hardwood kraft pulp is subjected to the TCF multi-step bleaching comprising xylanase treatment, alkaline extraction, hydrogen peroxide treatment, and ozone treatment. The bleached pulp is refined such that the freeness becomes 450 ml. 100 parts by mass of the obtained pulp is mixed with 3 parts by mass of kaolin filler, 6 parts of light calcium carbonate filler, and 0.2 part by mass of alkenylsuccinic acid anhydride (ASA) internal sizing agent, and the mixture is subjected to papermaking.

Separately, a coating liquid (as a surface sizing liquid) containing 80 parts by mass of water, 12 parts by mass of calcium hydrogen carbonate, and 8 parts by mass of an oxidized starch prepared by dry oxidation is prepared. The sheet obtained above is subjected to a size pressing with the coating liquid, so that a recording sheet having a basic weight of 68 g/m² is obtained, wherein the surface of the recording sheet has 1.5 g/m² of calcium hydrogen carbonate and 1.0 g/m² of the oxidized starch prepared by dry oxidation.

### Example 4

Softwood kraft pulp is subjected to a bleaching treatment with hydrosulfite, then refined such that the freeness becomes 450 ml. 100 parts by mass of the obtained pulp is mixed with 8 parts by mass of light calcium carbonate filler and 0.02 part by mass of alkenylsuccinic acid anhydride (ASA) internal sizing agent, and the mixture is subjected to papermaking.

Separately, a coating liquid (as a surface sizing liquid) containing 75 parts by mass of water, 15 parts by mass of magnesium hydroxide, and 10 parts by mass of an enzymatically-modified starch obtained by treating commercially available Irish potato starch with α-amylase is prepared. The sheet obtained above is subjected to a size pressing with the coating liquid, so that a recording sheet having a basic weight of 82 g/m² is obtained, wherein the surface of the recording sheet has 2.0 g/m² of magnesium hydroxide and 1.5 g/m² of the enzymatically-modified starch.

### Example 5

Hardwood kraft pulp is subjected to the ECF bleaching in the same manner as in Example 2. The bleached pulp is refined such that the freeness becomes 450 ml. 100 parts by mass of the obtained pulp is mixed with 15 parts by mass of light calcium carbonate filler and 0.1 part by mass of alkenylsuccinic acid anhydride (ASA) internal sizing agent, and the mixture is subjected to papermaking.

Separately, a coating liquid (as a surface sizing liquid) containing 90 parts by mass of water, 5 parts by mass of the oxidized starch used in Example 3, and 5 parts by mass of calcium hydroxide is prepared. The sheet obtained above is subjected to a size pressing with the coating liquid, so that a recording sheet having a basic weight of 55 g/m² is obtained, wherein the surface of the recording sheet has 0.6 g/m² of the oxidized starch and 0.6 g/m² of calcium hydroxide.

### Example 6

Papermaking is conducted in the same manner as in Example 5. Separately, a coating liquid (as a surface sizing liquid) containing 60 parts by mass of water, 30 parts by mass of the oxidized starch used in Example 3, and 10 parts by mass of calcium lactate is prepared. The sheet obtained above is subjected to a size pressing with the coating liquid, so that a recording sheet having a basic weight of 55 g/m² is obtained, wherein the surface of the recording sheet has 4.5 g/m² of the oxidized starch and 1.5 g/m² of calcium lactate.

### Example 7

Papermaking is conducted in the same manner as in Example 5. Separately, a commercially available aqueous cornstarch dispersion liquid is mixed with an aqueous sodium hypochlorite solution and left for 2 hours at pH 10 to give an oxidized starch. A coating liquid (as a surface sizing liquid) containing 75 parts by mass of water, 10 parts by mass of the enzymatically-modified starch used in Example 2, 5 parts by mass of the oxidized starch obtained above, and 10 parts by mass of calcium lactate is prepared. The sheet obtained above is subjected to a size pressing with the coating liquid, so that a recording sheet having a basic weight of 55 g/m² is obtained, wherein the surface of the recording sheet has 1.5 g/m² of the enzymaticall-modified starch, 0.8 g/m² the oxidized starch and 1.5 g/m² of calcium lactate.

### Comparative Example 1

Hardwood kraft pulp is subjected to the TCF bleaching in the same manner as in Example 3. The bleached pulp is refined such that the freeness becomes 450 ml. 100 parts by mass of the obtained pulp is mixed with 3 parts by mass of light calcium carbonate filler, 3 parts by mass of saponite filler, and 2 part by mass of neutral rosin sizing agent, and the mixture is subjected to papermaking.

Separately, a commercially available aqueous cornstarch dispersion liquid is mixed with an aqueous sodium hypochlorite solution and left for 3 hours at pH 8 to give an oxidized starch. A coating liquid (as a surface sizing liquid) containing 65 parts by mass of water, 15 parts by mass of the oxidized starch obtained above, and 20 parts by mass of calcium hydroxide is prepared. The sheet obtained above is subjected to a size pressing with the coating liquid, so that a recording sheet having a basic weight of 100 g/m² is obtained, wherein the surface of the recording sheet has 2.0 g/m² of the oxidized starch and 2.5 g/m² of calcium hydroxide.

### Comparative Example 2

Hardwood kraft pulp is subjected to the TCF bleaching in the same manner as in Example 3. The bleached pulp is refined such that the freeness becomes 450 ml. 100 parts by mass of the obtained pulp is mixed with 15 parts by mass of light calcium carbonate filler, and 0.1 parts by mass of alkenylsuccinic acid anhydride (ASA) sizing agent, and the mixture is subjected to papermaking.

Separately, a coating liquid (as a surface sizing liquid) containing 80 parts by mass of water, 10 parts by mass of sodium chloride, and 10 parts by mass of calcium hydroxide is prepared. The sheet obtained above is subjected to a size pressing with the coating liquid, so that a recording sheet having a basic weight of 64 g/m² is obtained, wherein the surface of the recording sheet has 2.0 g/m² of sodium chloride and 2.0 g/m² of calcium hydroxide.

### Comparative Example 3

Hardwood kraft pulp is subjected to the TCF bleaching in the same manner as in Example 3. The bleached pulp is refined such that the freeness becomes 450 ml. 100 parts by mass of the obtained pulp is mixed with 20 parts by mass of kaolin filler, 0.05 part by mass of alkylketene dimer (AKD) sizing agent, and the mixture is subjected to papermaking.

Separately, a coating liquid (as a surface sizing liquid) containing 92 parts by mass of water, 5 parts by mass of the oxidized starch prepared as described in Comparative example 1, and 3 parts by mass of calcium thiocyanate is prepared. The sheet obtained above is subjected to a size pressing with the coating liquid, so that a recording sheet having a basic weight of 64 g/m² is obtained, wherein the surface of the recording sheet has 0.05 g/m² of calcium thiocyanate and 0.07 g/m² of the oxidized starch.

### Comparative Example 4

Hardwood kraft pulp is subjected to the TCF bleaching in the same manner as in Example 3. The bleached pulp is refined such that the freeness becomes 450 ml. 100 parts by mass of the obtained pulp is mixed with 20 parts by mass of kaolin filler, 0.05 part by mass of alkylketene dimer (AKD) sizing agent, and the mixture is subjected to papermaking.

Separately, a coating liquid (as a surface sizing liquid) containing 40 parts by mass of water, 30 parts by mass of the enzymatically-modified starch used in Example 2, and 30 parts by mass of calcium thiocyanate is prepared. The sheet obtained above is subjected to a size pressing with the coating liquid, so that a recording sheet having a basic weight of 68 g/m² is obtained, wherein the surface of the recording sheet has 5.0 g/m² of calcium thiocyanate and 5.0 g/m² of the enzymatically-modified starch.

### Comparative Example 5

Papermaking is conducted in the same manner as in Example 5. Separately, a coating liquid (as a surface sizing liquid) containing 77 parts by mass of water, 15 parts by mass of the enzymatically-modified starch used in Example 2, 5 parts by mass of commercially available oxidized starch (ACE C, manufactured by Oji Cornstarch Co., Ltd.), and 3 parts by mass of sodium sulfate is prepared. The sheet obtained above is subjected to a size pressing with the coating liquid, so that a recording sheet having a basic weight of 70 g/m² is obtained, wherein the surface of the recording sheet has 2.0 g/m² of the enzymaticall-modified starch, 0.7 g/m² the oxidized starch and 0.06 g/m² of sodium sulfate.

Measurement of Properties of Recording Sheets

The properties of the obtained recording sheets are measured as described below. The Stöckigt sizing degree is measured according JIS-P-8122:1976 in a standard condition (23° C. 50%RH). The surface electric resistivity and volume electric resistivity are measured according to JIS-K-6911 in the standard condition. The smoothness is measured by an Ohken digital-display air-permeability smoothness measuring instrument type EY (manufactured by Asahi Seiko Co., Ltd.) according to JIS-P-8119:1998. The formation index is measured by a micro formation tester, using a 3-D sheet analyzer (M/K950) manufactured by M/K Systems, Inc. with analyzer diaphragm set to a diameter of 1.5 mm.

Evaluation of Properties of Hot Water Extract

Each recording sheet is cut into a piece with an area of 0.06 m². The piece is subjected to Soxhlet extraction at 100° C. for 8 hours. Then, the extract is dried and solidified. The weight of the solid, the carboxyl group content of the solid, and the IR absorption spectrum of the solid are measured. The measurement of the carboxyl group content is conducted as follows.

The carboxyl group content is measured based on the direct titration method of Matisson & Legendre. Specific procedures are described below. 0.1N hydrochloric acid is added to 0.15 g of the solid obtained by the hot water extraction and the mixture is stirred for 30 minutes. The mixture is placed on a glass filter and washed with pure water until chlorine ion disappears from the filtrate, wherein the existence of chlorine ion in the filtrate is confirmed by dropwise adding a silver nitrate solution to the filtrate and checking if white precipitate develops. The washed solid is placed in a beaker and dispersed in 300 ml of pure water, then heated and dissolved. Thereafter, the solution is titrated with a 0.01N sodium hydroxide solution using phenolphthalein as the indicator. The carboxyl group content is calculated according to the following equation.
Carboxyl group content (meq/100 g)=amount of consumed sodium hydroxide solution (ml)×0.01 (normality of the sodium hydroxide solution, mol/l)×100/0.15

The results of the measurements of the properties of the hot water extract is shown in Tables 4 and 5, together with the composition of the processing liquid used in the preparation of the recording sheets.

The curl after printing and transferability of the recording sheets are evaluated according to the following criteria, using an electrophotographic recording apparatus DOCUCENTRECOLOR 400CP manufactured by Fuji Xerox Co., Ltd. The results are shown in Tables 4 and 5.

Evaluation of Curl After Printing

Each recording sheet (cut into A4 size) is left in a condition of 23° C. 65% RH for 8 hours so as to control the moisture content. Same text images having an image density of 5% are sequentially printed on 10 recording sheets of each example or comparative example, using only black ink. The recording sheets are placed on a flat measuring table immediately after the printing. Then, the vertical distances between the table and four vertices are measured in each recording sheet. The maximum vertical distance of 40 vertices (4 vertices×10 sheets) is determined (the measurement accuracy is at mm level). The maximum vertical distance is evaluated according to the following criterion, wherein only the rank A is practically acceptable.
Rank A: the maximum vertical distance is shorter than 25 mm
Rank B: the maximum vertical distance is 26 mm to 35 mm
Rank C: the maximum vertical distance is longer than 36 mm
   Evaluation of Transferability

The printed image obtained above is checked and the degree of the occurrence of mottles caused by transfer defect is determined. The evaluation criterion is as described below, wherein only the rank A is practically acceptable.
Rank A: no image density mottle is observable
Rank B: slight image density mottle is observable
Rank C: severe image density mottle is observable all over the image
   Evaluation of Image Optical Density

The image optical density is evaluated according to the following criterion, using an ink-jet recording apparatus WORKCENTRE B900 manufactured by Fuji Xerox Co., Ltd. The results are shown in Tables 4 and 5. At the printing, the condition is 23° C. 50% RH; the nozzle pitch is 800 dpi; the number of nozzles are 256; the drop amount is approximately 15 pl; the maximum jetting amount of the ink and the preprocessing liquid is approximately 15 ml/m²; the printing mode is one-side batch printing; and the head scanning speed is approximately 1100 mm/sec. In the ink-jet recording apparatus, the black ink is a pigment ink and the color inks are dye inks. The evaluation criterion is explained below.

One day after the printing, the image optical densities of the solid patch areas of black and magenta are measured, using an X-RITE 369 (manufactured by X-rite) and an average value thereof (the average value of the optical density of the black solid patch area and the optical density of the magenta solid patch area) is calculated. The evaluation criteria is as follows, wherein only the ranks A and B are practically acceptable.
Rank A: the average value is 1.5 or higher
Rank B: the average value is 1.0 or higher but lower than 1.5
Rank C: the average value is lower than 1.0

In Tables 4 and 5, L-BKP represents Laulholz Bleached Kraft Pulp, N-BMP represents Nadelholz Bleached Mechanical Pulp, N-BKP represents Nadelholz Bleached Kraft Pulp, and L-BSP represents Laulholz Bleached Sulfite Pulp. The oxidized starch prepared by dry oxidation is expressed as “dry-process oxidized starch” in Tables 4 and 5.

TABLE 4

| | Example | Example | Example | Example | Example | Example |
|---|---|---|---|---|---|---|
| | 2 | 3 | 4 | 5 | 6 | 7 |
| Pulp | L-BKP | L-BKP | N-BMP | L-BKP | L-BKP | L-BKP |
| | ECF | TCF | hydrosulfite | ECF | ECF | ECF |
| Freeness | 450 ml | 450 ml | 450 ml | 450 ml | 450 ml | 450 ml |
| Basic weight (g/m²) | 64 | 68 | 82 | 55 | 55 | 55 |
| Filler (% relative to pulp) | Bentonite 10 | Kaolin 3 | | | | |
| | Light calcium | Light calcium | Light calcium | Light calcium | Light calcium | Light calcium |
| | carbonate 10 | carbonate 6 | carbonate 8 | carbonate 15 | carbonate 15 | carbonate 15 |
| Internal sizing agent | AKD 0.1 | ASA 0.2 | ASA 0.02 | ASA 0.1 | ASA 0.1 | ASA 0.1 |
| (% relative to pulp) | | | | | | |
| Surface sizing liquid | Enzymatically- | Dry-process | Enzymatically- | Dry-process | Dry-process | Enzymatically- |
| composition (wt %) | modified | oxidized | modified | oxidized | oxidized | modified |
| | starch 6 | starch 8 | starch 10 | starch 5 | starch 30 | starch 10 |
| | | | | | | Oxidized |
| | | | | | | starch 5 |
| | Sodium | Calcium | Magnesium | Calcium | Calcium | Calcium |
| | chloride 6 | hydrogen | hydroxide 15 | hydroxide 5 | lactate 10 | lactate 10 |
| | | carbonate 12 | | | | |
| Applied amount (g/m²; | Enzymatically- | Dry-process | Enzymatically- | Dry-process | Dry-process | Enzymatically- |
| solid amount per one side) | modified | oxidized | modified | oxidized | oxidized | modified |
| | starch 1.0 | starch 1.0 | starch 1.5 | starch 0.6 | starch 4.5 | starch 1.5 |
| | | | | | | Oxidized |
| | | | | | | starch 0.8 |
| | Sodium | Calcium | Magnesium | Calcium | Calcium | Calcium |
| | chloride 1.0 | hydrogen | hydroxide 2.0 | hydroxide 0.6 | lactate 1.5 | lactate 1.5 |
| | | carbonate 1.5 | | | | |
| Solid amount of hot water | 0.07 | 0.12 | 0.13 | 0.06 | 0.35 | 0.22 |
| extract from 0.06 m² piece (g) | | | | | | |
| Carboxyl group content | 0.56 | 2.00 | 1.30 | 2.10 | 2.60 | 2.93 |
| in the solid (meq/100 g) | | | | | | |
| IR absorption peak | observable | observable | observable | observable | observable | observable |
| unique to starch | | | | | | |
| Surface resistivity/ | 0.83 | 0.43 | 0.38 | 0.33 | 0.11 | 0.11 |
| volume resistivity | | | | | | |
| Surface resistivity (Ω/sq) | 1.5 × 10¹⁰ | 3.2 × 10¹⁰ | 1.5 × 10¹⁰ | 6.5 × 10⁹ | 7.5 × 10⁹ | 7.5 × 10⁹ |
| Volume resistivity (Ω · cm) | 1.8 × 10¹⁰ | 7.5 × 10¹⁰ | 4.0 × 10¹⁰ | 2.0 × 10¹⁰ | 6.7 × 10¹⁰ | 6.7 × 10¹⁰ |
| Carboxyl group content | 1.3 | 2.6 | 1.5 | 2.6 | 2.6 | 2.87 |
| in starch (meq/100 g) | | | | | | |
| Stöckigt sizing degree (s) | 10 | 16 | 10 | 20 | 15 | 15 |
| Smoothness (s) | 25 | 70 | 85 | 100 | 100 | 100 |
| Formation index | 20 | 30 | 38 | 35 | 30 | 30 |
| Curl after thermal fixing | A | A | A | A | A | A |
| Transferability in | A | A | A | A | B | B |
| electrophotography | | | | | | |
| Ink-jet image | B | A | B | B | B | A |
| optical density | | | | | | |

TABLE 5

| | Comparative | Comparative | Comparative | Comparative | Comparative |
|---|---|---|---|---|---|
| | example 1 | example 2 | example 3 | example 4 | example 5 |
| Pulp | L-BKP | L-BSP | N-BKP | L-BSP | L-BKP |
| | TCF | TCF | TCF | TCF | TCF |
| Freeness | 450 ml | 450 ml | 450 ml | 450 ml | 450 ml |
| Basic weight (g/m²) | 100 | 64 | 64 | 68 | 70 |
| Filler (% relative to pulp) | Light calcium | | | | |
| | carbonate 3 | | | | |
| | Saponite 3 | Light calcium | Kaolin 20 | Kaolin 20 | Kaolin 20 |
| | | carbonate 15 | | | |
| Internal sizing agent | Neutral | ASA 0.1 | AKD 0.05 | AKD 0.05 | AKD 0.05 |
| (% relative to pulp) | rosin 2 | | | | |
| Surface sizing liquid | Oxidized | Sodium | Oxidized | Enzymatically- | Oxidized starch 5 |
| composition (wt %) | starch 15 | chloride 10 | starch 5 | modified | Enzymatically- |
| | | | | starch 30 | modified starch 15 |
| | Calcium | Calcium | Calcium | Calcium | Sodium |
| | hydroxide 20 | hydroxide 10 | thiocyanate 3 | thiocyanate 30 | sulfate 3 |
| Applied amount (g/m²; | Oxidized | Sodium | Oxidized | Enzymatically- | Oxidized starch 0.7 |
| solid amount per one side) | starch 2.0 | chloride 2.0 | starch 0.07 | modified | Enzymatically- |
| | | | | starch 5.0 | modified starch 2.0 |
| | Calcium | Calcium | Calcium | Calcium | Sodium |
| | hydroxide 2.5 | hydroxide 2.0 | thiocyanate 0.05 | thiocyanate 5.0 | sulfate 0.06 |
| Solid amount of hot | 0.19 | 0.19 | 0.004 | 0.480 | 0.23 |
| water extract from | | | | | |
| 0.06 m² piece (g) | | | | | |
| Carboxyl group content | 5.78 | 0.00 | 7.58 | 0.55 | 5.37 |
| in the solid (meq/100 g) | | | | | |
| IR absorption peak | observable | non-observable | observable | observable | observable |
| unique to starch | | | | | |
| Surface resistivity/ | 0.02 | 0.06 | 0.5 | 0.06 | 0.11 |
| volume resistivity | | | | | |
| Surface resistivity (Ω/sq) | 1.0 × 10⁹ | 5.0 × 10⁸ | 6.5 × 10¹¹ | 8.9 × 10⁹ | 7.5 × 10¹⁰ |
| Volume resistivity (Ω · cm) | 5.0 × 10¹⁰ | 7.8 × 10⁹ | 1.3 × 10¹² | 1.5 × 10¹¹ | 6.7 × 10¹¹ |
| Carboxyl group content | 13.9 | — | 13.9 | 1.3 | 4.62 |
| in starch (meq/100 g) | | | | | |
| Stöckigt sizing degree (s) | 25 | 10 | 5 | 80 | 25 |
| Smoothness (s) | 120 | 18 | 90 | 100 | 100 |
| Formation index | 35 | 6 | 38 | 20 | 20 |
| Curl after thermal fixing | C | B | C | A | C |
| Transferability in | A | C | A | B | B |
| electrophotography | | | | | |
| Ink-jet image | B | A | B | C *1 | C |
| optical density | | | | | |

*1 Ink hardly penetrates into the recording sheet, so that mottle occurs in solid image areas

As is clear from Tables 4 and 5, when electrophotograhic printing is conducted on the recording sheet of the invention, the curl after thermal fixing is suppressed and transfer defect does not occur. When ink-jet printing is conducted on the recording sheet of the invention, high color rendition can be obtained.

As described above, the invention can provide a recording sheet and an image forming method using the recording sheet. The recording sheet can be used for both electrophotograhic recording and ink-jet recording. When the recording sheet of the invention is used for electrophotographic recording, occurrence of curl is suppressed while the transferability is maintained as high as conventional sheets. When the recording sheet of the invention is used for ink-jet recording, excellent color rendition can be obtained.

Further, the invention can also provide a recording sheet obtained by a method in which a starch is used as a surface sizing agent. When the recording sheet is used in electrophotographic or ink-jet copying machines and printers, curl can be suppressed. The invention also provides an image recording method using the recording sheet.

What is claimed is:

1. A recording sheet obtained by coating a base paper including pulp with a surface sizing agent including a starch as a main component, wherein when the recording sheet is left in a condition of 23° C. 50% RH for 5 hours and then the surface of the recording medium is provided with a povidone-iodine liquid having a povidone-iodine concentration of 70 mg/ml and an effective iodine content of 7 mg/ml in an amount of 10 ml/m² and then the recording sheet is left in a condition of 23° C. 50% RH for 5 hours, the reflection density of the surface provided with the povidone-iodine liquid is 0.60 or lower.

2. The recording sheet according to claim 1, wherein the starch is prepared by a method comprising:
mixing a starch and water to form an aqueous starch solution;
heating the aqueous starch solution, so as to gelatinize the aqueous starch solution; then
aging the aqueous starch solution at a temperature which is lower than a heating temperature of the gelatinization; then
enzymatically modifying the starch by adding an enzyme to the aqueous starch solution; and then
heating the aqueous starch solution so as to inactivate the enzyme and to stop the reaction.

3. The recording sheet according to claim 1, wherein when 0.06 m² of the recording sheet is subjected to hot water extraction, a solid amount of an extract is from 0.01 to 0.4 g and a carboxyl group content in the solid is from 0 to 5 meq/100 g.

4. The recording sheet according to claim 3, wherein the recording sheet further includes a filler.

5. The recording sheet according to claim 1, wherein the surface sizing agent includes a di- or higher-valent metal, and in a condition of 23° C. 50% RH, the recording sheet has a ratio of a surface electric resistivity to a volume electric resistivity in the range of from 0.1 to 1, the surface electric resistivity of from 1.0×10⁹ to 1.0×10¹¹ Ω/sq, and the volume electric resistivity of from 5.0×10⁹ to 5.0×10¹¹ Ω·cm.

6. The recording sheet according to claim 3, wherein the surface sizing agent includes a di- or higher-valent metal, and in a condition of 23° C. 50% RH, the recording sheet has a ratio of a surface electric resistivity to a volume electric resistivity in the range of from 0.1 to 1, the surface electric resistivity of from 1.0×10⁹ to 1.0×10¹¹ Ω/sq, and the volume electric resistivity of from 5.0×10⁹ to 5.0×10¹¹ Ω·cm.

7. A method for producing a recording sheet comprising:
mixing a starch and water to form an aqueous starch solution;
heating the aqueous starch solution, so as to gelatinize the aqueous starch solution; then
aging the aqueous starch solution at a temperature which is lower than a heating temperature of the gelatinization; then
enzymatically modifying the starch by adding an enzyme to the aqueous starch solution; then
heating the aqueous starch solution so as to inactivate the enzyme and to stop the reaction to obtain an enzymatically-modified starch;
preparing a surface sizing agent including the enzymatically-modified starch as a main component; and
coating a base paper including pulp with the surface sizing agent.

8. An electrophotographic image recording method comprising:
uniformly charging the surface of an electrostatic latent image holding member;
exposing the surface of the electrostatic latent image holding member to form an electrostatic latent image;
developing the electrostatic latent image with an electrostatic developer to form a toner image;
transferring the toner image to a surface of a recording sheet; and
fixing the toner image to the surface of the recording sheet,
wherein the recording sheet is obtained by coating a base paper including pulp with a surface sizing agent including a starch as a main component; and when the recording sheet is left in a condition of 23° C. 50% RH for 5 hours and then the surface of the recording medium is provided with a povidone-iodine liquid having a povidone-iodine concentration of 70 mg/ml and an effective iodine content of 7 mg/ml in an amount of 10 ml/m² and then the recording sheet is left in a condition of 23° C. 50% RH for 5 hours, the reflection density of the surface provided with the povidone-iodine liquid is 0.60 or lower.

9. An ink-jet image recording method comprising putting ink droplets to a surface of a recording sheet to form an image on the surface,
wherein the recording sheet is obtained by coating a base paper including pulp with a surface sizing agent including a starch as a main component; and when the recording sheet is left in a condition of 23° C. 50% RH for 5 hours and then the surface of the recording medium is provided with a povidone-iodine liquid having a povidone-iodine concentration of 70 mg/ml and an effective iodine content of 7 mg/ml in an amount of 10 ml/m² and then the recording sheet is left in a condition of 23° C. 50% RH for 5 hours, the reflection density of the surface provided with the povidone-iodine liquid is 0.60 or lower.

10. A recording sheet prepared by coating the surface of a base paper including a pulp and a filler as main components with a processing liquid including a starch, wherein when 0.06 m² of the recording sheet is subjected to hot water extraction, a solid amount of an extract is from 0.01 to 0.4 g and a carboxyl group content in the solid is from 0 to 5 meq/100 g.

11. The recording sheet according to claim 10, wherein the processing liquid includes a di- or higher-valent metal salt, and in a condition of 23° C. 50% RH, the recording sheet has a ratio of a surface electric resistivity to a volume electric resistivity in the range of from 0.1 to 1, the surface electric resistivity of from 1.0×10⁹ to 1.0×10¹¹ Ω/sq, and the volume electric resistivity of from 5.0×10⁹ to 5.0×10¹¹ Ω·cm.

12. The recording sheet according to claim 1, wherein a carboxyl group content of the starch in the processing liquid is from 0 to 5 meq/100 g.

13. The recording sheet according to claim 10, wherein the starch is prepared by a method comprising:
mixing a starch and water to form an aqueous starch solution;
heating the aqueous starch solution, so as to gelatinize the aqueous starch solution; then
aging the aqueous starch solution at a temperature which is lower than a heating temperature of the gelatinization; then
enzymatically modifying the starch by adding an enzyme to the aqueous starch solution; and then
heating the aqueous starch solution so as to inactivate the enzyme and to stop the reaction.

14. The recording sheet according to claim 11, wherein the starch is prepared by a method comprising:
mixing a starch and water to form an aqueous starch solution;
heating the aqueous starch solution, so as to gelatinize the aqueous starch solution; then
aging the aqueous starch solution at a temperature which is lower than a heating temperature of the gelatinization; then
enzymatically modifying the starch by adding an enzyme to the aqueous starch solution; and then
heating the aqueous starch solution so as to inactivate the enzyme and to stop the reaction.

15. An electrophotographic image recording method comprising:
uniformly charging the surface of an electrostatic latent image holding member;
exposing the surface of the electrostatic latent image holding member to form an electrostatic latent image;
developing the electrostatic latent image with an electrostatic developer to form a toner image;
transferring the toner image to a surface of a recording sheet; and
fixing the toner image to the surface of the recording sheet,
wherein the recording sheet is prepared by coating the surface of a base paper including a pulp and a filler as main components with a processing liquid including a starch; and when 0.06 m² of the recording sheet is subjected to hot water extraction, a solid amount of an extract is from 0.01 to 0.4 g and a carboxyl group content in the solid is from 0 to 5 meq/100 g.

16. An ink-jet image recording method comprising putting an ink droplet including a colorant and at least one of water and a water soluble solvent, to a surface of a recording sheet to form an image on the surface,
wherein the recording sheet is prepared by coating the surface of a base paper including a pulp and a filler as main components with a processing liquid including a starch; and when 0.06 m² of the recording sheet is subjected to hot water extraction, a solid amount of an extract is from 0.01 to 0.4 g and a carboxyl group content in the solid is from 0 to 5 meq/100 g.
